(19) United States
(12) Patent Application Publication
(10) Pub. No.: US 2003/0014317 A1
(43) Pub. Date: Jan. 16, 2003

(54) Client-side E-commerce and inventory management system, and method

(76) Inventors: Stanley M. Siegel, Yukon, PA (US); Darren M. Siegel, Yukon, PA (US)

Correspondence Address: Richard C. Litman, Litman Law Offices, Ltd., Crystal City Station, P.O. Box 15035, Arlington, VA, 22215-0035, US

(21) Appl. No.: 09/902,797

(22) Filed: Jul. 12, 2001

(51) Int. Cl. G06G 1/14; G06F 17/60

(52) U.S. Cl. 705/22; 705/28

(57) ABSTRACT

An inventory management system that integrates online and “bricks and mortar” point-of-sale inventory, sales and operations data without requiring a dynamic web host. Software residing on a merchant's in store computer performs all of the inventory database functions and serves as an in store point-of-sale terminal. Merchandise is presented online on customized web pages on a static website, without the merchant having to use scripts. Images and product information can be searched by category or using a search engine which indexes and manages HTML and non-HTML information. The software automatically tracks the inventory from online and in store sales and generates web pages of the merchant's website changed as a result of changes in the program's inventory database. It also can make reports on expenses, sales and profits, is compatible with hardware interfaces, can print receipts and barcodes, and can handle shipping and sales tax as well as vendor, customer and employee information.

### RELATED APPLICATIONS

This application is a related application to U.S. patent application Ser. Nos. 09/630,475, 09/630,476, 09/630,593, and 09/630,865, all filed on Aug. 1, 2000, and claims priority from these applications.

### BACKGROUND OF THE INVENTION

1. Field of the Invention

The present invention relates to inventory management systems and, more particularly, to a client-side e-commerce and inventory management system, and method, which also integrates point-of-sale and Internet operations.

2. Description of the Related Art

The need for efficient and effective electronic business management systems is increasing in the current market. Small retail business owners in particular generally do not have the funds to acquire or use large servers and the computing power needed to compete with large retailers with online merchandising capabilities. Online commerce systems also lack compatibility with their physical counterparts, often selling out of stock items before the system can be updated. Retail customers searching and shopping online become dissatisfied by these negative experiences, resulting in poor results for small retail businesses embarking on offering products online as well as in their stores.

Given the importance of e-commerce, it is no surprise that several other inventors have proposed various processes and systems for electronic merchandising. Conventional methods of conducting commerce over the Internet require a web server capable of not only serving standard HTML web pages, but also capable of performing all of the inventory and product pricing calculations as well. Specifically, e-commerce web servers require a traditional HTTP (hypertext transfer protocol) web host that is connected to the inventory or product database through a dynamic data connectivity interface. In this traditional implementation the web pages contain either small embedded software programs (called scripts), or they contain calls to ordinary computer programs that reside on the server. When the customer accesses the merchant's website, the scripts or programs insert the output of the program into the web page and serves this completed page back to the customer.

Some popular implementations of this e-commerce scheme include websites that reside on web hosts such as Microsoft's Internet Information Server as the HTTP web host, and provide the database such as Microsoft Access or SQL Server, and have pages that incorporate server components such as Microsoft's Active Server Pages (ASP), Java Server Pages (JSP), Perl, and other technologies such as executables and .DLL's. The purpose of including all of these components on the server is to allow pages that display the contents of the website as the user of the site requests them, which allows any changes to the database, such as inventory changes or pricing changes, to be reflected in real-time. As such, it can accurately reflect the current product inventory at any given moment and the database can readily be synchronized with conventional in store sales data to provide a single inventory and product management system.

However, the shortcomings of the hosted solution forces the merchant to face other more critical problems. One is the Internet connectivity that is necessary to effectively implement this mode of e-commerce. Because the solution offering is not a product or software package that resides on the merchant's own computer, the merchant is forced to log onto the ASP's Internet server in order to build and/or make changes to their website. This means that the merchant's progress is now at the mercy of the performance of their Internet connection to conduct business. In order for the merchant to maintain an adequate level of inventory control, the merchant is required to establish a near continuous and high-speed connection to the Internet and their Web hosted database. This relates to increased costs associated with possibly upgrading hardware and a more robust Internet connection.

Another issue the merchant now faces is security. The merchant's business critical information, such as inventory, pricing, sales, customers, etc., now resides on a third party's server. Because this information is not on a database that the merchant controls, the possibly of breaches of security from hackers is increased. Also, in many cases, the merchant is locked to that service. Because the merchant's website and information resides on the server provided by the solution provider, the merchant is unable to choose a different hosting provider for their website. This further contributes to the merchant's diminishing level of control over their e-commerce business.

For smaller merchants without a technical staff and wit limited resources, there is no way to sell their products online in a way that allows them to manage their inventory and synchronize their online sales with their conventional in store sales. None of these server side hosted database application systems are integrated with in store point-of-sale systems without high integration costs from the use of technical personnel skilled in HTML, computer programming, and database design. This forces the merchant to run their online business and their existing business separately.

Because the merchant's resulting web site pages are processed by the web server before they are served to the customer, these dynamic web sites are slower than static web sites that use only HTML. In addition, conventional systems exist for generating entire websites based on a database and template files that reside on a personal computer. While these systems generate static sites that contain information from the database, there is no system for automatically recreating these pages when changes to the database are made.

All prior art requires either ASP model server services, or an on-site server with Internet backbone connection. The costs associated with purchasing the necessary hardware, software, connections, cables and peripherals makes this solution virtually unattainable for smaller merchants.

The present invention addresses these problems directly by providing a system that allows the online and “bricks and mortar” sales and inventory data to be integrated without requiring a dynamic web host. Instead, the present invention provides a software program which can reside on a merchant's in store personal computer that performs all of the inventory database functions of the database in the dynamic web server context, but which can also double as an in store point-of-sale terminal, and which has the ability to simultaneously generate all web pages of the merchant's static web site based on the information changes in the program's inventory database. The advantage of this is that that merchant does not have to write any HTML, and they can host their web site on any one of a myriad of static website hosting providers. These static hosts are far less expensive than the dynamic hosts, and the pages can be retrieved by Internet surfing customers much faster.

Specifically, the present invention uses the data in its inventory database to generate all of the HTML pages for every product in the database, as well as index and category pages that organize the information for customers. Once the pages are generated they are transferred to the web host (“uploaded”) via the Internet standard File Transfer Protocol (“FTP”). These pages contain only HTML code and scripts; they do not contain any executable program components. The merchant has the ability to use a secure payment gateway, or to accept online orders via email only.

When a customer places a secure order on the web site using a credit card or check, the secure online payment gateway server processes the transfer of funds from the customer's account to the merchant's account and sends an email to the merchant's POP3 email server address containing the order and customer information.

When a customer places an un-secure order on the web site, the web site sends an email to the merchant's POP3 email server address that contains the order and customer information. The merchant's software retrieves the order emails (placed using either secure payment gateway or direct email) from the merchant's email address for processing and fulfillment.

Once the orders are processed and the merchant's inventory is updated, this updated inventory information is used to generate updated information for the web site, which are uploaded. The updated inventory information also simultaneously updates the merchant's in store point-of-sale system. This system keeps the website and in store inventory system synchronized in a way that is efficient, easy, and automatic. Unlike the prior art, the instant invention requires the merchant to establish an Internet connection only when they are uploading their website information to the third party web server, or retrieving orders from their email server.

Without the direct use of Hyper-Text Markup Language (HTML) code, the user may create a custom web page through a “set up wizard” to add color, backgrounds, frames, links, and sounds or use templates to add variety. Items may be photographed and displayed on the web pages and can be customized and organized for easier access. The search engine is specially formatted to deal with a group of similarly created and managed electronic retail web sites.

The search engine gives retailers the ability to advertise and promote specific items or groups of items on a main search site to promote sales. Such a search page may include banners of featured items with descriptions from different web stores within the group as well as links to those sites. Additionally a links page may be included to display a list of pertinent related sites.

The search engine also provides the consumer with the ability to browse possible retail sites by categories defined by the owner of the sites. Similarly items from multiple retail sites can be accessed and displayed by category with information from the their associated sites.

The search engine is able to handle queries in multiple word forms, space delineated forms, and using Boolean operators. The engine searches all existing on-line stores within the retail group for the word or phrase requested and display associated available items. Items returned by the search engine are categorized by owner's site and include hyperlinks to reach these sites. These hyperlinks lead directly to the item on the owner's website and may open up a new window of the web browser.

Customers visiting the website may give feedback in the form of comments and a rating system. Such comment and ratings may be viewed by the owner as well as future visitors to the site to provide a level of confidence in the site. Feedback may only be given by registered customers to protect against unprovoked or malicious responses. Such a registration includes personal information and an email address which may be used as the unique login to the system.

Examples of previous electronic merchandising approaches are as follows.

U.S. Pat. No. 5,694,551, issued on Dec. 2, 1997 to John D. Doyle et al., describes a computer integrated network for channeling customer orders through a centralized computer to various suppliers. Customers have access to an electronic catalog and are able to place orders through a central computer system which then sends the orders to associated internal suppliers or outside vendors who ship directly to the customer.

U.S. Pat. No. 5,721,906, issued on Feb. 24, 1998 to David M. Siefert, describes a system for managing resources which can take the form of computer-compatible information, such as data files and program, non-computer-compatible information, such as data contained on microfiche, and physical objects. Such resources are located at geographically different locations, and are given descriptive profiles that may be searched by a user in order to retrieve such a resource. A selected resource may then be ordered and delivered to an authorized user.

U.S. Pat. No. 5,727,164, issued on Mar. 10, 1998 to Eugene G. Kaye et al., describes an apparatus and method for managing the availability of items using a computer system. Such a system allows a variety of computers to access a database of categorized items.

U.S. Pat. No. 5,825,881, issued Oct. 20, 1998 to Bryan Colvin, Sr., describes a system for conducting electronic commerce over the Internet. Such a system serves as a link between merchants, customers, and a bank or credit card processor.

U.S. Pat. No. 5,890,136, issued on Mar. 30, 1999 to Ludwig Kipp, describes a mass retail system for ordering and purchasing items electronically for pickup at an automated store.

U.S. Pat. No. 5,924,094, issued on Jul. 13, 1999 to Herbert P. Sutter, describes an independent distributed database system including a plurality of sites that may work offline using local data. Each stores only the data it needs while an online transaction occurs only when necessary to update or change a system.

U.S. Pat. No. 5,940,807, issued Aug. 17, 1999 to Daniel S. Purcell, describes a method for controlling the collection, processing, and dissemination by a host regarding product or service availability. Sellers approved by the host are granted access to the system for providing inventory information. Such information is organized and cross referenced with a buyers list to provide for a purchase transaction.

U.S. Pat. No. 6,003,019, issued on Dec. 14, 1999 to Morag M. Eaton et al., describes a multiple transaction service system in which a customer can request and receive financial service. Such a service can be accessed through a variety of different channels that are all connected through a channel manager.

U.S. Pat. No. 6,067,527, issued on May 23, 2000 to Christopher D. Lovell et al., describes a point of sale system and a method of operation and a control program for use within the point of sale system. Such a system includes a remote site that communicates with the site controller through a communication link.

European Patent document 0 697 669 A2, published on Feb. 21, 1996, describes an electronic sourcing system and method that maintains a database of product information related to items available from vendor catalogs. Information about the item includes identification of the item so that a user may find the item by searching using a specific word or phrase. The system can check to see if the requested item is available in one or more inventories and may generate a purchase order.

Japan Patent document 10-320494, published on Dec. 12, 1998, describes a central market system which informs a market client system of market setting information such as market contents, market setting time or the like from a notifying part.

Other electronic management processes are shown in patent disclosures, but none of them disclose an organization of an electronic business or distribution setup as disclosed herein. For example, U.S. Pat. No. 5,729,733, issued on Mar. 17, 1998 to Jamshid Sharif-Askary, discloses a method of maintaining a distributed database among independently operable sites in which database availability is not interrupted during database update.

U.S. Pat. No. 5,734,719, issued on Mar. 31, 1998 to James T. Tsvedos et al., discloses a digital information accessing, delivery, and production system. U.S. Pat. No. 5,884,035, issued on Mar. 16, 1999 to Ronald A. Butman et al., discloses a dynamic distributed group registry apparatus and method for collaboration and selective sharing of information. U.S. Pat. No. 5,911,143, issued on Jun. 8, 1999 to Klaus Deinhart et al., discloses a method and system for registration, authorization, and control of access rights computer system.

U.S. Pat. No. 5,918,227, issued on Jun. 29, 1999 to Dean Polnerow et al., discloses an online directory service with a plurality of databases and a processing system with a plurality of processors. U.S. Pat. No. 5,956,727, issued on Sep. 21, 1999 to Tu-An Cheng et al., discloses a heterogeneous database system which includes plural database systems, wherein one of the database systems acts as a system manager. U.S. Pat. No. 5,987,506, issued on Nov. 16, 1999 to John B. Carter et al., discloses a computer system which employs a globally addressable storage environment that allows a plurality of networked computers to access data by addressing even when the data is stored on a persistent storage device such as a computer hard disk and other traditionally non-addressable data storage devices.

U.S. Pat. No. 6,014,639, issued on Jan. 11, 2000 to Steffan M. Fohn et al., discloses an electronic catalog system for exploring a multitude of hierarchies using attribute relevance and forward checking. Japan Patent document 11-161673, published on Jun. 18, 1999, describes a catalog generation system.

Other patents relating to inventory or financial management systems include U.S. Pat. No. 5,897,622 issued on Apr. 27, 1999 to Arnold Blinn et al., which discloses a merchant system for online shopping and merchandising which generates Internet pages dynamically on an Internet server utilizing a database schema. Similarly, U.S. Pat. No. 6,021,396, issued on Feb. 1, 2000 to Sanjay E. Ramaswamy et al., also uses an Internet server for a software application which reorders items when quantities become low. U.S. Pat. No. 5,920,848 issued on Jul. 6, 1999 to Daniel Schutzer et al., is for a financial transaction and accounting system on a network such as the Internet which collects information and generates various reports. None of these patents integrate point-of-sale and Internet operations according to the claimed invention.

Lastly, examples of web page generators include U.S. Pat. No. 5,940,834, issued on Aug. 17, 1999 to Debbie Pinard et al., which disclose a web page generator for automatic web page creation in an Internet and Intranet environment after being placed on a web server, and U.S. Pat. No. 6,247,032, issued on Jun. 12, 2001 to Richard S. Bernardo et al., which shows a software tool for use with a computer system to simplify the creation of Web sites using pre-stored templates without the website creator having to write any HTML or other programming code, and to enable multiple collaborators to prepare the content for the website.

None of the above inventions and patents, taken either singularly or in combination, is seen to describe the instant invention as claimed. Thus a client-side e-commerce and inventory management system, and method, which also integrates point-of-sale and Internet operations and solves the aforementioned problems is desired.

### SUMMARY OF THE INVENTION

The present invention is a client-side e-commerce and inventory management system, and method, which also integrates point-of-sale and Internet operations. The system automatically lists inventory for sale on a customized website according to user input and electronic and physical sales. The system tracks inventory, expense, and sales for use in organization and managing a business.

Accordingly, it is a principal object of the invention to provide an inventory management system to integrate point-of-sale and Internet operations.

It is another object of the invention to provide an organized manner in which a merchant user can conduct electronic retail commerce on one or more websites while taking into account the physical inventory in an actual store, or series of stores.

It is a further object of the invention to provide a safe and secure operating environment for a merchant to run an electronic retail store, without the merchant's business database being uploaded to the Internet.

It is a further object of the invention to provide an Internet electronic commerce web site, integrated with point-of-sale, and inventory management system that does not rely on server-side software and is not hosted on a web server.

Still a further object of the invention is to provide a merchant the flexibility to host the electronic commerce site system on the merchant's own computer, with or without a web server, or on any static server or a host provider of choice.

Still a further object of the invention is to enable a merchant to generate web pages for a public website or websites on the merchant's client-side computer and then upload the resulting files to any Internet web server on which the merchant has an account via standard FTP protocol.

Still another object of the invention is to allow for an efficient manner to conduct electronic retail commerce that does not interrupt or take away from the physical storefront, and allows both point-of-sale and Internet sales to be made from a common synchronized inventory.

Still another object of the invention is to help electronic retail business owners manage their online store inventory, sales, and employees.

A further object of the invention is to assist electronic business owners to organize themselves by generating useful reports on sales, profits, customers, inventory and expenses.

Still another object of the invention is to provide a business process that includes a customer search engine for use within a group of similarly created and managed online electronic storefronts.

It is another object of the invention to provide a search engine to list stores or items within the group by category as defined by the user.

It is a further object of the invention to provide for a search engine which provides return information via hypertext links so as to be easily accessible by the user.

Still another object of the invention is to provide a level of confidence in the electronic stores by allowing a consumers to give feedback to be displayed on such a site.

It is an object of the invention to provide improved components and arrangements thereof in an inventory management system to integrate point-of-sale and Internet operations for the purposes described which is inexpensive, transferable, secure, dependable, and fully effective in accomplishing its intended purposes.

These and other objects of the present invention will become readily apparent upon further review of the following specification and drawings.

### BRIEF DESCRIPTION OF THE DRAWINGS

A detailed description of the preferred embodiment is provided herein below, with reference to the following drawings, in which:

FIG. 1 is a block diagram of the prior art approach to e-commerce with a conventional web host and conventional dynamic web server including a database, scripting software and a regular non-specialized web server. This system can be provided by a third party application service provider/web hosting provider, or is purchased by and resides on site at the merchant's location.

FIG. 2A is an overall flow diagram of all of the Internet-related communications of the invention system.

FIG. 2B is a technology flow diagram of e-commerce according to the present invention.

FIG. 3.1 is a flow diagram of the template driven process.

FIG. 3.2 is a flow diagram of the initial process of designing and uploading a website.

FIG. 3A is a screen shot showing information input fields for the website title, the email address and the domain name of the website.

FIG. 3B is a screen shot showing information input fields for the merchant's contact information such as address and telephone number.

FIGS. 3C (1 through 7, inclusive) are screen shots showing information input fields for the merchant to add items to the inventory.

FIG. 3D is a screen shot showing a selection menu for a merchant to select a template for the merchant's website.

FIGS. 3E (1 through 6, inclusive) are screen shots depicting screens the merchant completes for designing/customizing a website.

FIG. 3F is a screen shot of the completed website being previewed from the merchant's machine browser.

FIGS. 3G (1 through 6, inclusive) are screen shots depicting screens where the merchant establishes how to calculate, collect and report taxes for both online and in-store transactions.

FIGS. 3H (1 and 2) are screen shots depicting screens where the merchant establishes how to calculate and collect shipping charges for both online and in-store transactions.

FIGS. 3I (1-2) are illustrations depicting screens where the merchant establishes what methods and terms of payment they will accept for both online and in-store transactions.

FIG. 3J is a screen shot depicting a screen where the merchant establishes the merchant establishes the means to accept secure payments for online transactions.

FIGS. 3K (1 through 3, inclusive) are screen shots depictin screens where the merchant establishes their website hosting settings, and email settings for receiving email orders.

FIGS. 3L (1 through 3, inclusive) are screen shots showing detailed employee information, including permissions granted or withheld for operating/accessing information in the system.

FIGS. 3M (1 and 2) are screen shots of security information and controls for employees.

FIG. 4 is a schematic block diagram illustrating an overall inventory management system which automates the entire order entry and fulfillment process in accordance with the invention through monitoring quantity levels and reorder points, supporting inventory control and Just-in-Time ordering, and employing barcode technology.

FIG. 4A is a screen shot showing the full featured integrated point-of-sale system integrating in-store purchases with online purchases.

FIGS. 4B (1 through 6, inclusive) are screen shots depicting inventory control screens enabling a merchant to process online sales from the same inventory as the point-of-sale system.

FIGS. 4C (1 through 4, inclusive) are screen shots displaying information enabling the merchant to automatically track and manage customer information, purchasing history and payments.

FIGS. 4D (1 through 3, inclusive) are screen shots displaying information enabling the merchant to manage inventory by tracking information about vendors and the products they supply.

FIG. 4E is an illustration showing a site selection menu where the merchant elects to import information from or export information to other accounting software packages.

FIGS. 5A and 5B are block diagrams of the method for indexing and managing a searchable community of HTML and non-HTML information according to the present invention using an existing search engine model.

FIGS. 6A and 6B are block diagrams of the method for indexing and managing a searchable community of HTML and non-HTML information according to the present invention using a community search engine.

Similar reference characters denote corresponding features consistently throughout the attached drawings.

### DETAILED DESCRIPTION OF THE PREFERRED EMBODIMENTS

The present invention is an inventory management system to integrate point-of-sale and Internet operations. It also enables a merchant to generate a customized e-commerce website through a template driven process. A customer can use a specially designed search engine in connection with the website and a community of similarly constructed sites. The invention disclosed herein is, of course, susceptible of embodiment in many different forms.

The invention may be used to expand any type of conventional business having at least one point-of-sale (e.g., “bricks and mortar” facility, storefront, kiosk, catalog, etc.) into the field of electronic commerce, organization and management, with the preferred and suggested type being retail business with a physical store who also wants to sell merchandise on the Internet.

The Internet is a worldwide collection of computer networks connecting academic, governmental, commercial, and organizational sites. It provides access to communication services and information resources to millions of users around the globe. Internet services include direct communication (e-mail, chat), online conferencing (Usenet News, e-mail discussion lists), distributed information resources, (World Wide Web, Gopher), remote login and file transfer (such as File Transfer Protocol (FTP), which is a very common method of moving files between two Internet sites involving a special way to login to another Internet site for the purposes of retrieving and/or sending files), and many other valuable tools and resources. While the networks that make up the Internet are based on a standard set of protocols (a mutually agreed upon method of communication between parties), the Internet also has gateways to networks and services that are based on other protocols. The Internet connects millions of computers (hosts) worldwide. The underlying protocol with which these systems communicate is called TCP/IP. Any computer system directly connected to the network has a domain name (URL) and an IP (numeric) address.

The instant invention is used in connection with electronic commerce on the World Wide Web (Web or WWW). The Web is a global, virtual-network based hypertext information system that uses the Internet as its transport mechanism to display computer screens (or Web pages) of graphical, video, textual, and even audio information. In a hypertext system, one navigates by clicking hyperlinks, which display another document which also contains hyperlinks. In Web navigation, the next document seen could be housed on a computer next door or half-way around the world. Created in 1989 at a research institute in Switzerland, the Web relies upon browsers and the hypertext transport protocol (HTTP), an Internet standard that specifies how an application can locate and acquire resources stored on another computer on the Internet.

HTTP is the protocol for moving hypertext files across the Internet. It requires a HTTP client program on one end, and an HTTP server program on the other end. HTTP is the most important protocol used in the World Wide Web (WWW).

Most Web documents are created using Hyper Text Markup Language (HTML), a coding system for WWW documents used to develop and write web pages. Incorporating hypermedia (graphics, sounds, animations, video), the Web has become a popular medium for publishing information on the Internet. With the development of secured server protocol (HTTPS), the Web is now a commercial medium whereby consumers can browse on-line catalogs and purchase merchandise using secure, encrypted credit card information that is protected from interception.

The software of the invention may be configured for use on a program storage device, a computer usable medium, or a computer system. An appropriately configured program storage device readable by a machine would tangibly embody a program of instruction executable by the machine to perform method steps for enabling a user to generate, place, and move an e-commerce site anywhere on a computerized network, wherein the method steps would include communicatively connecting a client computer with a web generator web server, downloading e-commerce software from a web generator web server to a client computer, and generating an e-commerce web site on the client computer and uploading to an e-commerce web site anywhere on the computerized network.

An appropriately configured computer usable medium would have computer readable program code means embodied therein for generating, placing, and moving an e-commerce site anywhere on a computerized network, wherein the program code means would include computer readable program code means for generating, placing, and moving an e-commerce site anywhere on a computerized network, computer readable program code means for uploading a user's inventory, computer readable program code means for tracking company expenses, computer readable program code means for generating various reports, computer readable program code means for reordering items when quantities become low, and computer readable program code means for automatically calculating taxes and shipping charges.

An appropriately configured computer system would be able to generate, place, and move an e-commerce site anywhere on a computerized network, wherein the computer system would include a processor, a memory coupled to the processor, registers coupled to the processor, a computer readable medium coupled to the memory, wherein the computer usable medium would have computer readable program code means embodied therein for generating, placing, and moving an e-commerce site anywhere on a computerized network, the program code means including computer readable program code means for generating, placing, and moving an e-commerce site anywhere on a computerized network, computer readable program code means for uploading a user's inventory, computer readable program code means for tracking company expenses, computer readable program code means for generating various reports, computer readable program code means for reordering items when quantities become low, and computer readable program code means for automatically calculating taxes and shipping charges.

The software includes an application for the creation and uploading of an online electronic commerce site that may be used with the owner defined electronic inventory. The application assists an owner in the creation of a customized online electronic commerce site according to their input. The application has sound, image, text, and color options available to an owner to include on their site. These options may assist in displaying pertinent information as well as an aesthetic online shopping environment for the customer.

To enable secure online electronic and similar purchases an owner enters transaction information specific to their business into the program. The owner may also enter business contact information into the software so that other types of communications and transactions can be made such as electronic mail or a similar processes. Upon the completion of the online storefront design, the software may give the owner the option to view on the local system the fully constructed site before it is uploaded to an owner defined space and becomes a part of the electronic commerce community. The “electronic commerce community” is defined as a group or groups of online businesses constructed by similar software (specifically the one disclosed herein) and administered by a main electronic commerce site. The completed site may be uploaded to a space on any Internet web site hosting provider or similar online server. The software associates the created online storefront site with the main electronic commerce community site as defined by the software.

The electronic commerce community site will display a link to an item or category on the merchant's web site. When the link to the merchant's web site, item, or category is selected by a customer from the electronic commerce community site, the customer is forwarded to the merchant's web site with the specific item, shopping, and checkout options implemented. The electronic commerce community site will store an active inventory database consisting of items from the associated merchant's web site.

A user on a customer's computer may view and interact with the online store by accessing the electronic commerce community site administering the information in the electronic commerce community site as defined previously. Users may browse through the electronic commerce community site by store, category, or similar classification. Specific item images and information requested are downloaded from the owner's system through the main electronic commerce community site to the client computer for ease of browsing and purchasing.

Orders from users may be placed from the merchant's site by electronic mail, secure transaction, or a similar method. Unsecure orders taken by the merchant's site using a method such as electronic mail would trigger a message to the owner containing the order and associated pertinent information including a confirmation of the successful order to the user by a similar messaging method. Secured orders including but not limited to credit cards will be forwarded from the merchant's site to a secure credit card transaction processor site or similar site using a secure transaction link. The credit card or similar device is checked with the provider and a message is sent to a bank transaction site so that money may be transferred to the owner in exchange for goods and services. Upon recognition by the provider the order with the associated pertinent information is sent to the owner as well as a confirmation of the successful order to the user.

To allow for secure transactions the merchant's web site may employ a secure transaction link that forwards a user placed order of the secure type, such as with a credit card or a similar method, to a secured credit card transactions processor or a similar site.

Shown in the drawings and described herein below in detail is a preferred embodiment of the invention. It is to be understood, however, that the present disclosure is an exemplification of the principles of the invention and does not limit the invention to the illustrated embodiment.

A preferred and suggested embodiment of the software as shown in the Figures is an inventory management and e-commerce system to integrate point-of-sale and Internet operations which is installed on a retailer's local computer or network to allow the merchant to easily organize, manage and combine their physical and electronic storefronts. The software can be used to create and organize an electronic database of a merchant's physical inventory that may be associated with items for sale online. An inventory may be entered into the electronic database manually, by electronic scanning or by a similar method.

The system may allow for the electronic inventory to be a mixture of pre-barcoded and non-barcoded items. The non-barcoded items may be entered into the database and be given store owner defined barcodes to be easily cataloged into the system. For the non-barcoded items the store owner may use the software to define and create barcodes using a barcode template. All the barcoded items may then be inputted and removed from the electronic inventory using a laser barcode reader programmed and designed for the system. The software with the fully defined and organized inventory database may then be used to assist in the management, categorizing, re-ordering, and upkeep of the inventory.

The inventory management system is configured for use on a stand alone and/or a typical distributed computer system, wherein the merchant's computers are connected via a network to server computers. A server is a computer, or a software package, that provides a specific kind of service to client software running on other computers. The term can refer to a particular piece of software, such as a WWW server, or to the machine on which the software is running. A single server machine could have several different server software packages running on it, thus providing many different servers to clients on the network.

Software that runs on a server or web server is server-side software. Server-side electronic commerce software dynamically creates HTML web pages from a database located on the server in accordance with pre-formatted requests from an Internet client computer web browser received via HTTP protocol. The instant invention does not involve server-side software. Rather, this invention includes client-side, or non-server-side software. The software runs exclusively on a client computer without dependence upon a web server for the processing of any computer instructions. HTML and non-HTML Web pages are dynamically created on the client computer from a database stored on the client computer in accordance with pre-formatted rules stored on the same client computer. Created web pages and associated files are later uploaded to any web server via File Transfer (FTP) protocol as more fully described herein. The software of the inventory management system stands alone and does not require any addition online electronic commerce provider.

A typical combination of resources a merchant may have include client computers that are personal computers or workstations, and a web server that is a personal computer, a workstation, a minicomputer, and/or a mainframe. The network preferably comprises the Internet, although it could also comprise intranets, extranets, local area networks, wide area networks, etc. A computer system which is configured for use with the inventory management system preferably includes a web server, a client computer, and inventory software, which is stored in the client computer and enables the client computer. The computer system also includes a printing device electronically connected to the client computer, wherein the inventory software enables the printing device to print receipts, barcodes, and reports.

Each of the computers, be they client or a web server, generally include, inter alia, a processor, random access memory, data storage devices, data communications devices, a monitor, user input devices, etc. Those skilled in the art will recognize that any combination of the above components, or any number of different components, peripherals, and other devices, may be used with the client and web server.

Each of the computers, be they client or web server, operate under the control of an operating system, such as Windows, UNIX, etc. The operating system is booted into the memory of the computer for execution when the computer is powered-on or reset. In turn, the operating system then controls the execution of one or more computer programs by the computer. In the present invention, the operating system of the client controls the execution of a web browser and the operating system of the merchant's or third party's web server controls the execution of the web server. The web browser is typically a computer program such as Netscape, Microsoft Internet Explorer, etc.

The inventory management system is not limited to a single physical store or e-commerce site. The system has the capability of managing multiple e-commerce sites, enabling a merchant to run different sites under multiple domain names or through a portal system. Additionally, if the merchant is a chain, there can be replicated databases synchronizing, to create a similar process over multiple physical stores. The system can also be run on an Intranet such as used in kiosk or catalog store sales operations.

To guarantee secure interface with online customers the system is compatible with the hardware interfaces of signature card readers, barcode readers, magnetic card readers, credit card readers, and fingerprint readers for payment and access verifications.

The electronic store is able to keep track of the inventory so that, if elected by the merchant, customers cannot buy more items than available. Secure real time transaction can be made over the Internet as well as unsecured electronic mail purchases. When charging the customer the system may automatically include shipping and taxes according to rules set by the merchant. The system sets up a point-of-sale interface with barcode capability for product tracking and real time inventory updates based on sales. Additional equipment may be used for printing receipts and barcodes for a product mix of pre-barcoded and non-barcoded merchandise

The system software is able to generate full or quick reports on expenses, profits, sales, customers, inventory and supplies. It may also manage company expenses and alert the owner to the inventory when supplies are low. The software is also equipped with shipping information including charges and taxes. Several options are available including whether or not to apply tax which may be based on the customers state of residence and whether or not to charge for shipping which may be based on quantity, weight or amount spent.

The database also includes sections for inventory, customer, and employee information with a built in backup, repair, and restore routine. The system is compatible with current accounting software for importing and exporting files and may also include an integrated schedule and daily reminder option.

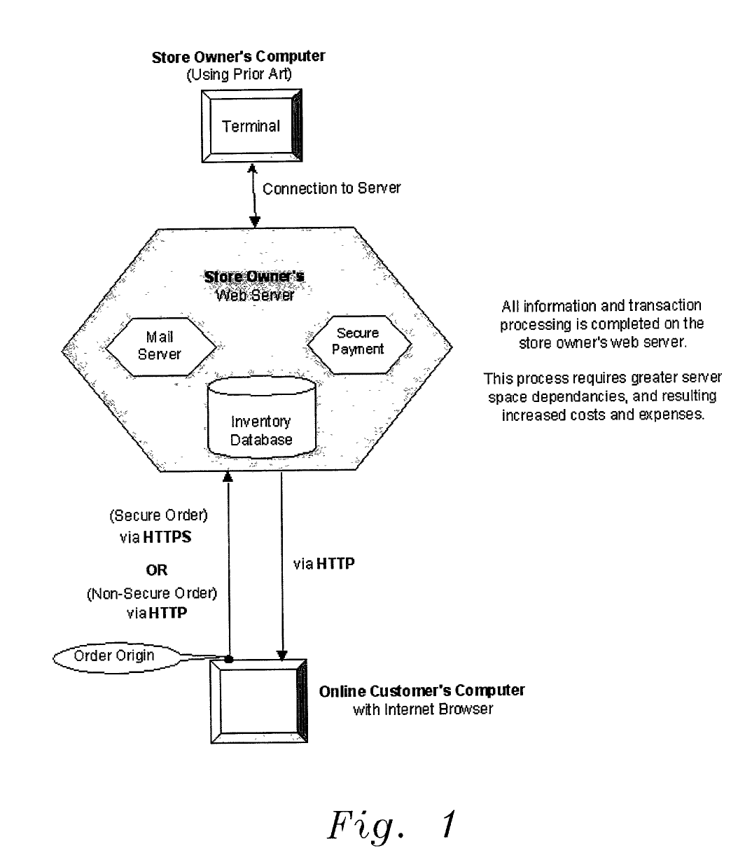

Turning now to the drawings, FIG. 1 shows a block diagram of the prior art approach to e-commerce with a conventional web host and conventional dynamic web server including a database, scripting software and a non-specialized web server. Note that because the inventory database is stored on the web server, each page is created fresh for each viewing based on inventory availability. With significant load the amount of time it takes to download a page from the server will become unreasonable, and potential sales are lost. Additionally because everything is done on the web server, large quantities of disk space must be leased, at ever increasing expense. The amount of available disk space must be continuously monitored to prevent the site from becoming unusable or unstable, forcing additional technical man-hours.

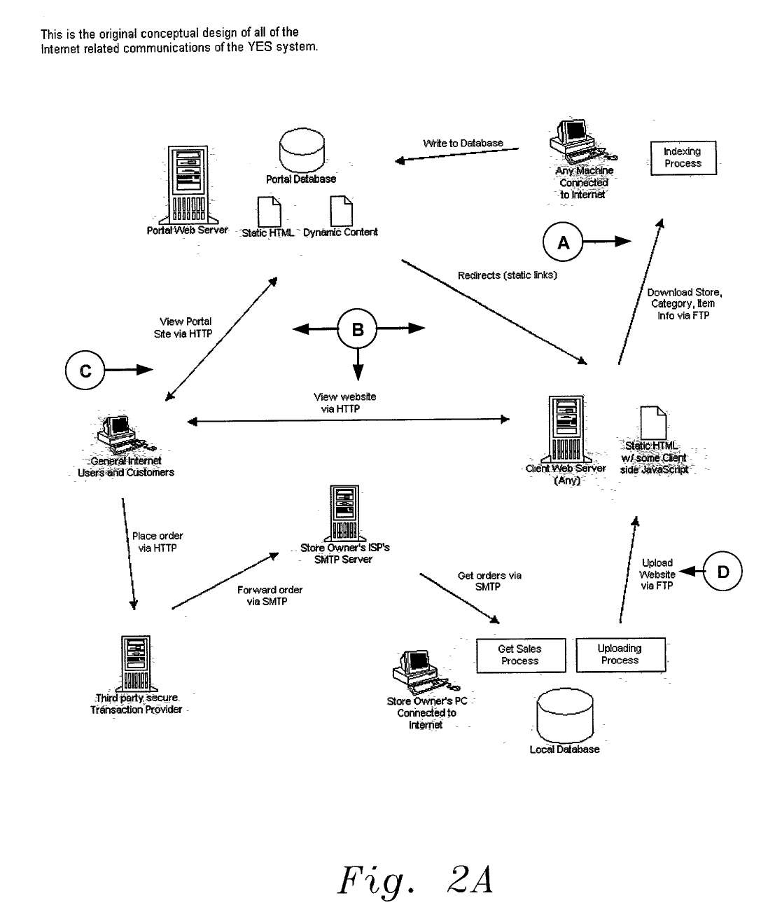

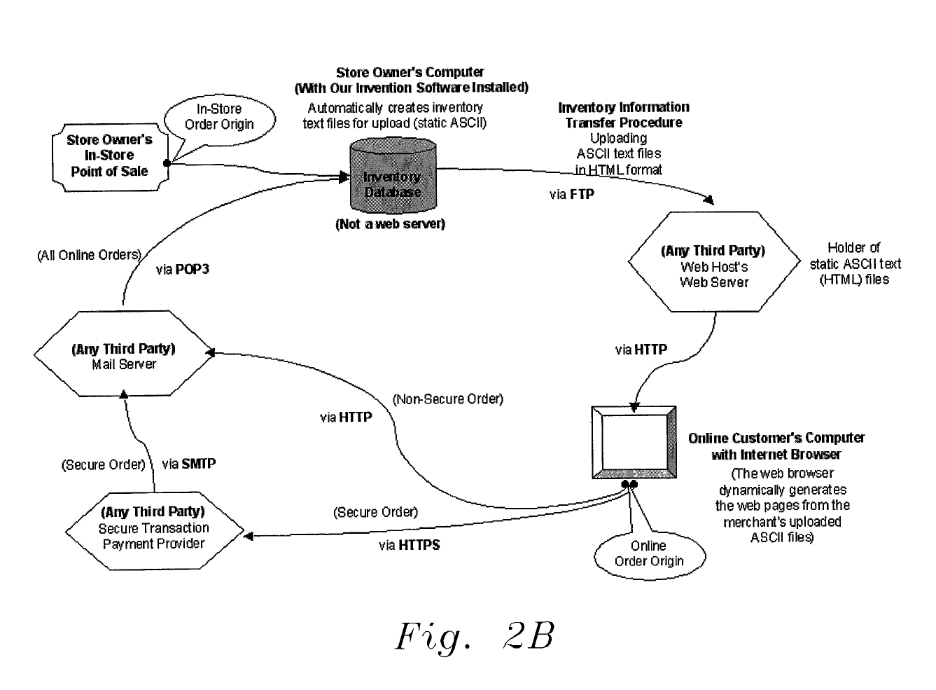

FIGS. 2A and 2B show a flow diagram of the invention, enabling an Internet platform to be created from software installed and operated locally by a merchant (storefront owner) on their own computer. No third party e-commerce provider is needed. Nor is any HTML or computer programming needed. The store owner can rent available space from any web hosting provider, or Internet Service Provider (ISP) with hosting capabilities, to provide access to the Internet and run standard HyperText Transport Protocol (HTTP) and File Transfer Protocol (FTP) services, not just specialized e-commerce servers.

The software enables the merchant to self generate a complete Internet storefront with complete e-commerce capabilities. Without having to depend on any other server applications, write HTML, scripts or program, the merchant can format the storefront, add items, and view the store locally with full functionality on its own computer.

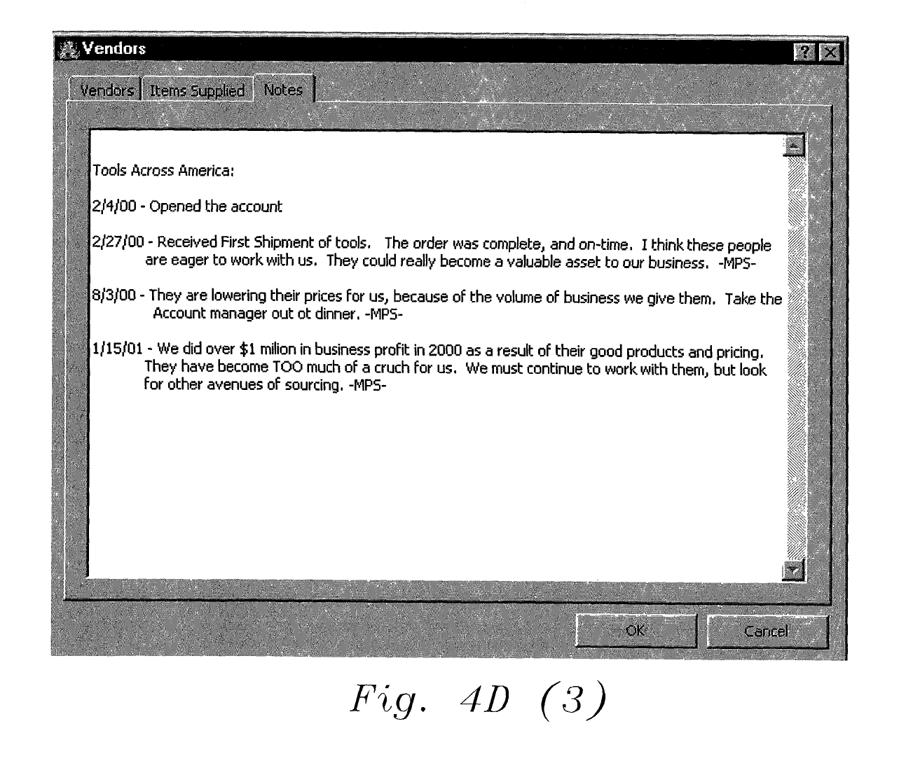

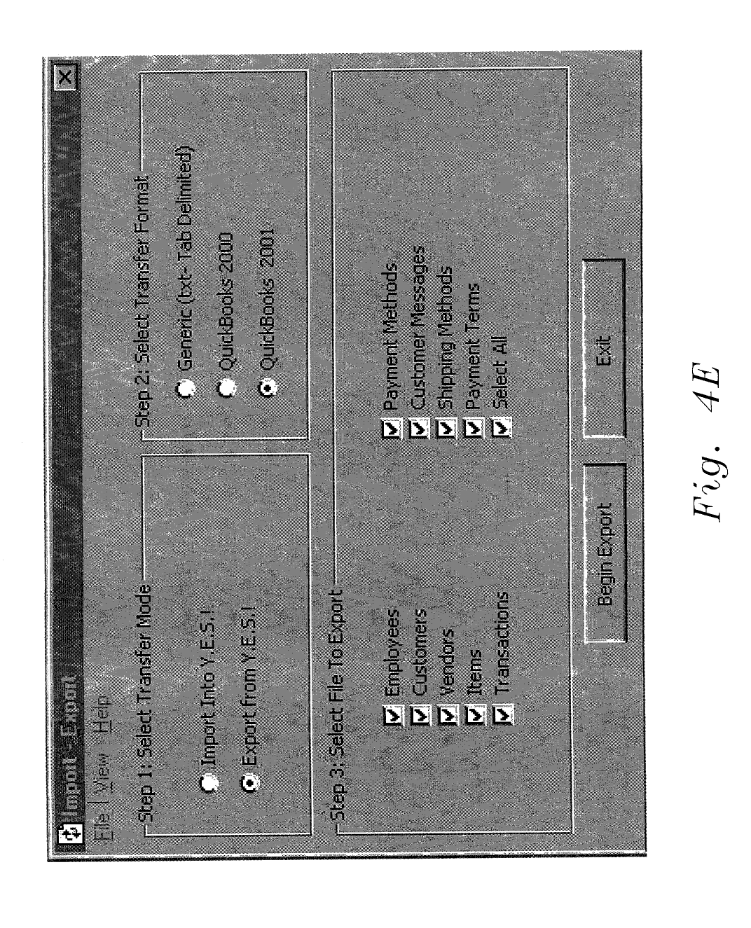

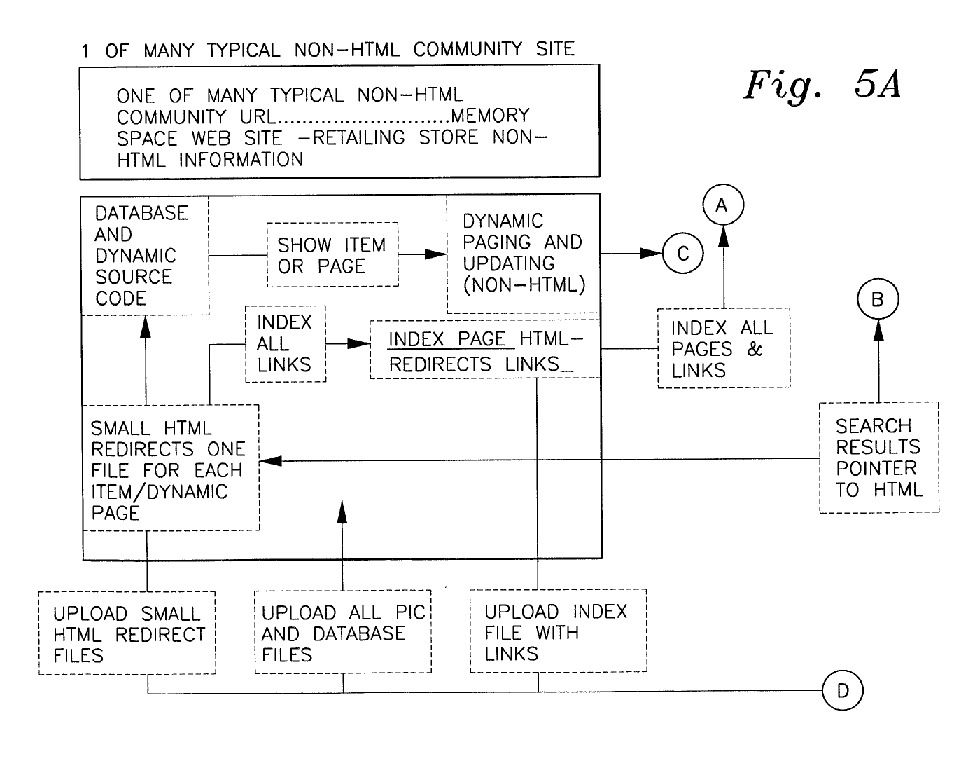

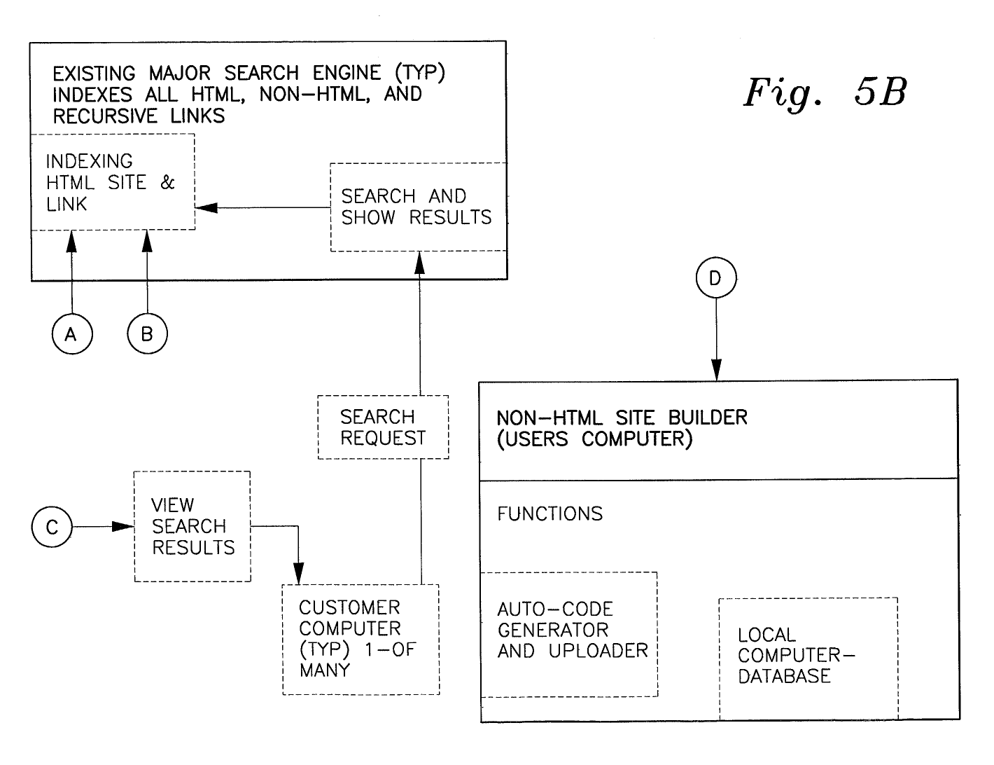

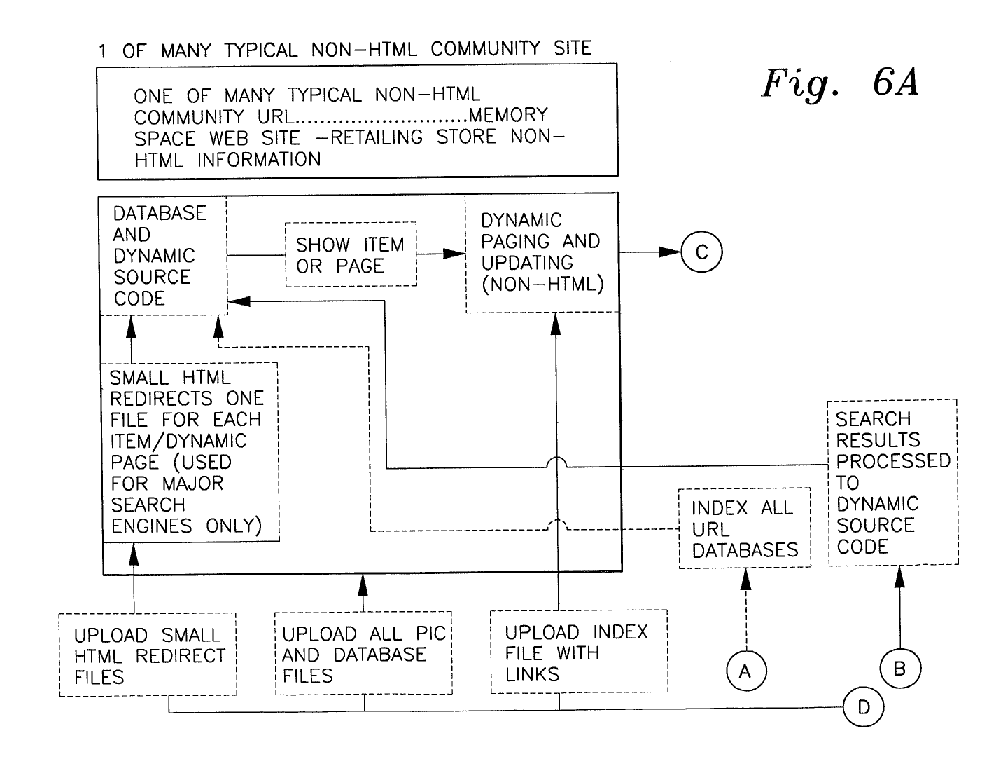

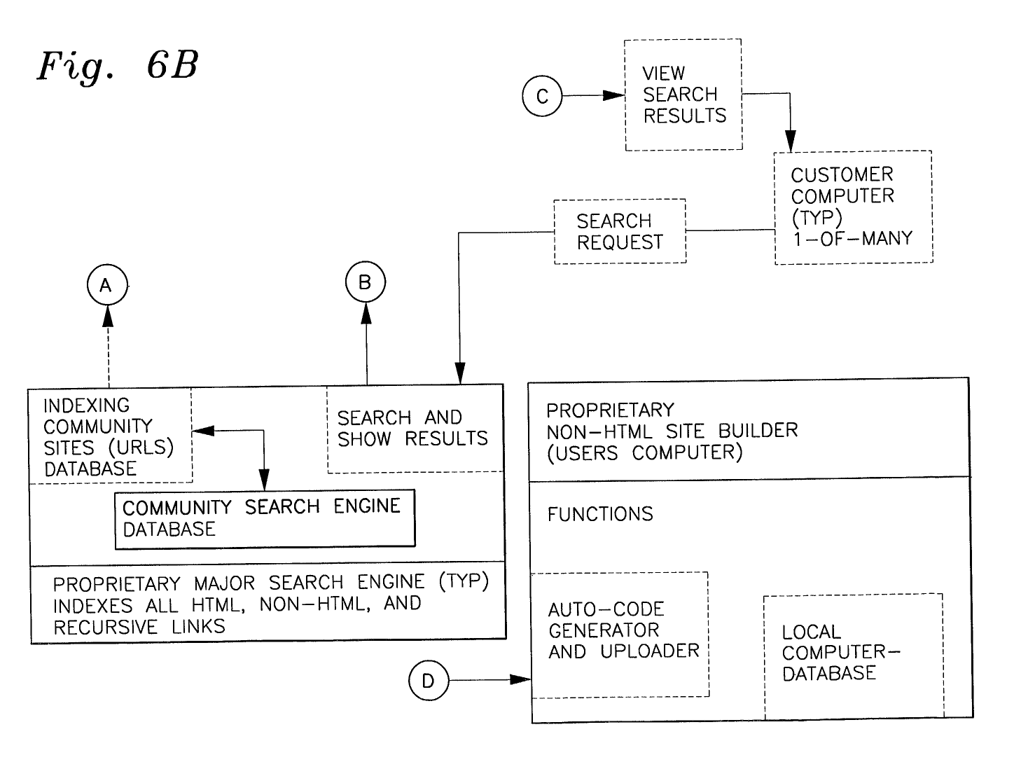

Without the direct use of Hyper-Text Markup Language (HTML) code the user may create a custom web page through a “set up wizard” to add color, backgrounds, frames, links, and sounds or use templates to add variety. Items to be sold via the online retail site may be photographed, or existing file images used, and associated with the items for display on the merchant's web site. The system creates descriptions and title fields for each item to be used in conjunction with an electronic commerce community search engine as shown in FIGS. 5A-5B, 6A-6B. Items are grouped into categories similar to retail sites so that they can be searched and viewed in an organized and efficient manner. The images and information are uploaded to a web server. When each item is selected for customer viewing, the item image and information is then downloaded from the merchant's web site web server to the customer computer. The customer's information is stored in a cookie on the customer's computer so that it will only have to be entered once.

Without having to have a database maintained elsewhere, the merchant can integrate the inventory for point-of-sale and Internet sales from one common point-of-sale database. The database also includes sections for vendor, customer, and employee information with a built in backup, repair, and restore routines.

The inventory takes the form of a database consisting of separate items each having their own associated images and details. The software may have predefined fields and a predefined organization for the entry and display of item details. The details to be inputted by the merchant may include costs, sales price, percent profit, weight, total sold, associated keywords, associated category, owner, catalog number, and description. Additional details may also be included as well in multiple areas designed as store owner defined fields. The electronic inventory database can be run in real time so that items sold from either the physical or online storefront are removed from the database and are no longer made available to customers for purchase. The electronic database may have preset reorder points to alert the merchant of a low stocked item.

Included in the electronic inventory system is an application for the maintenance of the electronic database. The system alerts the store owner to corruptions that can occur due to a system crash during a transaction or a similar situation and has the ability to fix such problems. The application, under the direction of the store owner may compress the information in the database to improve the performance of the system. A backup option may be used to save the entire database to a store owner defined location. In the case of data loss or a similar emergency the most recent backup save can be loaded to restore the system. The application also includes a sample database to give a store owner an idea of how the system will look and act with full input.

The system is compatible with current accounting software for importing and exporting files and may also include an integrated schedule and daily reminder option. Bar coded (or otherwise encoded) inventory can be used for both point-of-sale and Internet sales. With one mouse click on a computer in the merchant's physical storefront, without accessing a third party server side application, the merchant can format the online store front, add items and view a complete online store on its own computer. Each time the merchant's web site must be updated for inventory changes, the software only sends the pages, which need to be updated, decreasing the amount of time it takes to synchronize the systems.

In that the system is made up, but is not limited to, a program for the organization and management of a store owner's electronic inventory as well as their expenses, employees, customers, profits and other pertinent information, the store owner may import information to the system on these subjects from previously created information databases such as those created using other software.

Similarly, in that the program is integrated with the electronic database and is continuously updated due to physical or online sales, the program can create full reports on the items in a store owner's inventory according to the information in the electronic database. These reports may be specific and include information on groups of items, item details, items for sale electronically, items in the inventory, items out of stock and similar such subjects as selected by the owner. Even a quick item report may also be created giving information on a selected item.

Customer files stored by the program have information such as personal details, contact information, notes, transaction history, and similar information which can be viewed as either files or put into reports. Full reports can also be created to give information on all customers including statistics such as those based on types of payment, while a quick report would give information pertaining to a selected customer.

The program is also able to handle sales on consignment and organizes information about vendors of items in the electronic database. The system must have store owners assigned to all items in the systems database, and by default the system assigns the store owner to be the vendor for their items. However, reports may be generated on all vendors that have items in an electronic database including personal information, contact information and other similar pertinent information. Quick reports are similarly constructed but display details on a single vendor.

In addition, the program can keep track of and produce reports based on business expenses such as utilities, inventory stock and similar subjects. The program also assists the store owner in keeping records of employees. The records may be in the form of reports on all or specific employees with personal information, contact information and similar details. Owners may save daily reminders to be posted on the system for view and keep a current general information page pertaining to the business.

The program also contains specific applications for shipping and processing orders. Tax and shipping charges rules may be defined by the store owner and automatically be applied to orders by the program. Taxes may be selected to never be added, to be added with respect to a customer's state of residence, or differently for each item for both online and in-store sales. Current tax rates can be updated in the system for correct charges. Similarly shipping may be selected as no charges, based on amount of items selected, based on weight of total order, based cost of total order, or a fixed charge applied to all orders.

To enable secure online electronic and similar purchases an owner enters transaction information specific to their business into the program. The owner may also enter business contact information into the software so that other types of communications and transactions can be made, such as electronic mail or a similar processes.

Orders from users may be placed directly with the merchant's web site by electronic mail, secure transaction or a similar method. Unsecured orders taken by the commerce site using a method such as electronic mail would trigger a message to the owner containing the order and associated pertinent information including a confirmation of the successful order to the user by a similar messaging method. Secured orders including but not limited to credit cards would be forwarded from the merchant's web site to a secure credit card transaction processor site or similar site using a secure transaction link. The credit card or similar device is checked with the provider and a message is sent to the bank transaction site so that money may be transferred to the owner in exchange for goods and services. Upon recognition by the provider, the order with the associate pertinent information is sent to the owner as well as confirmation of the successful order to the customer.

To allow for secure transactions the merchant's web site may employ a secure transaction link that forwards a user placing order of the secure type, such as with a credit card or a similar method, to a secured credit card transaction processor or a similar site.

Inventory control is done in real-time from the point-of-sale database. The system automatically generates and, optionally, prints barcodes which can be placed on inventoried products for inventory control. Barcode identifications pre-printed by manufacturers may also be utilized. After only a minimal amount of initial set-up (inputting his/her company's name and address, defining taxation and shipping tables, selecting colors, background images, etc.), which needs to be done only once, the business' web site can be updated as frequently as desired to reflect current inventory levels and products available over the Internet with only a single click of the mouse. The system functions on a day-to-day level as a computer-based point-of-sale system that maintains a database of current inventory with re-order points, various reports, “cash-register” receipts, etc. Access by users to the point of sale system, as well as to other portions of the invention, are controlled by password and predefined security levels.

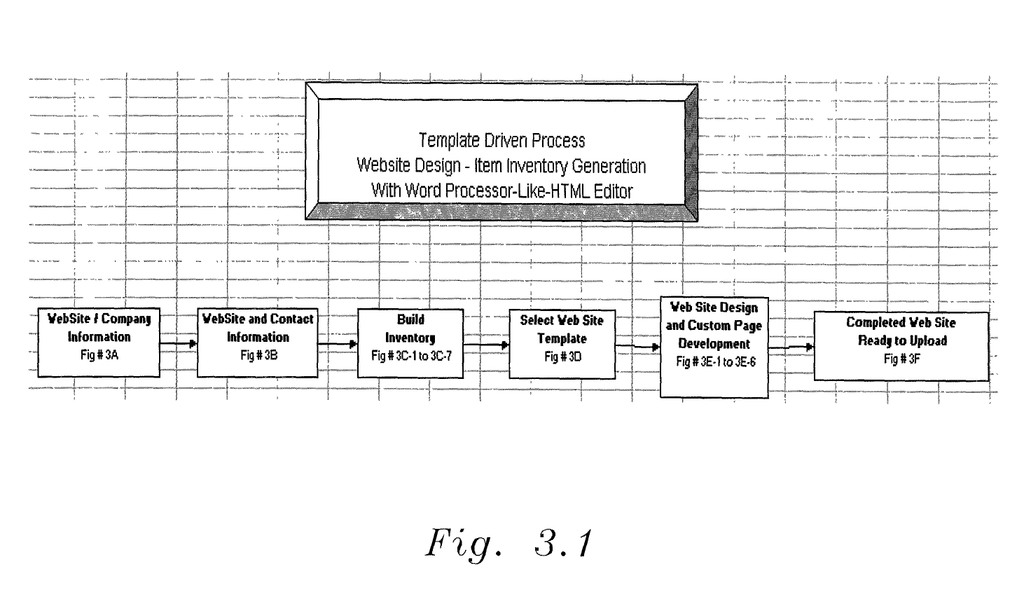

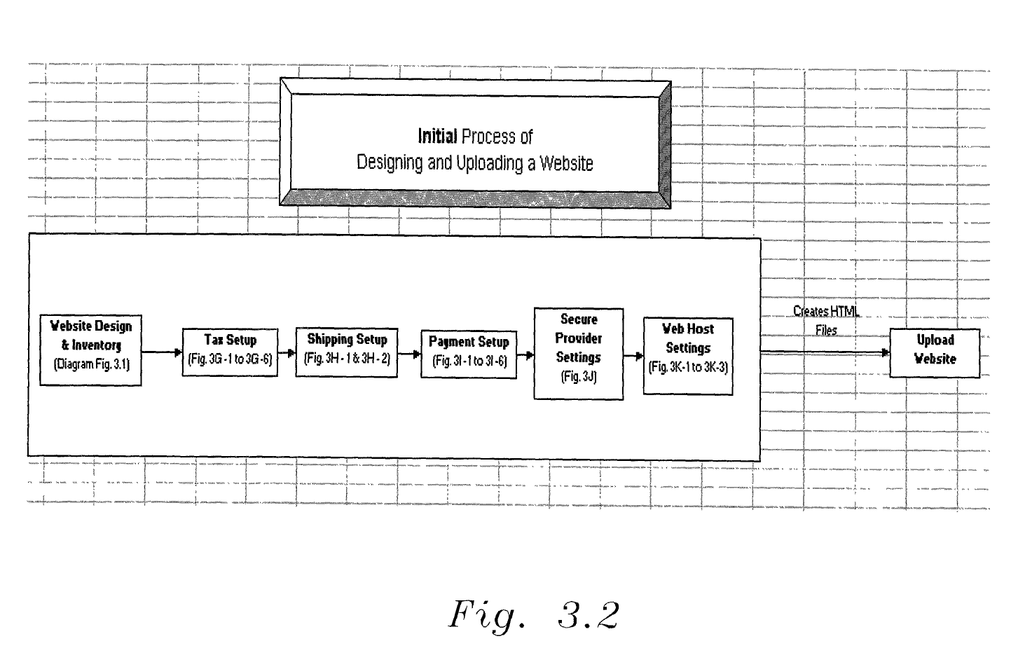

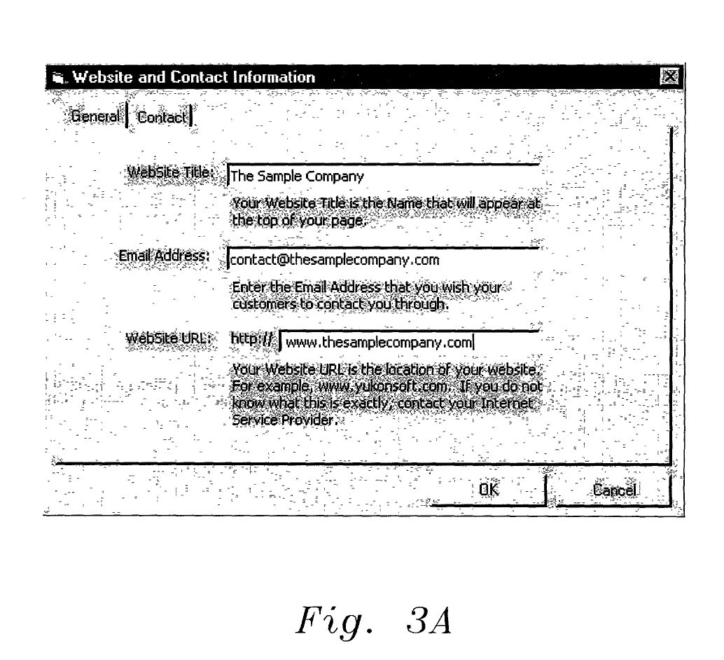

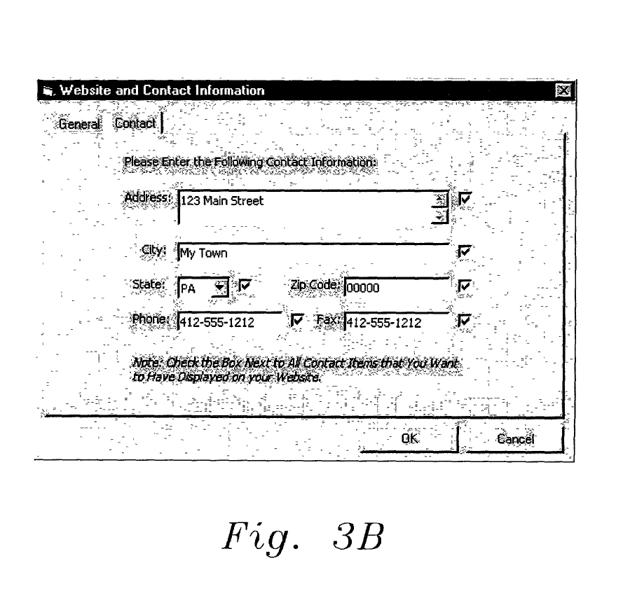

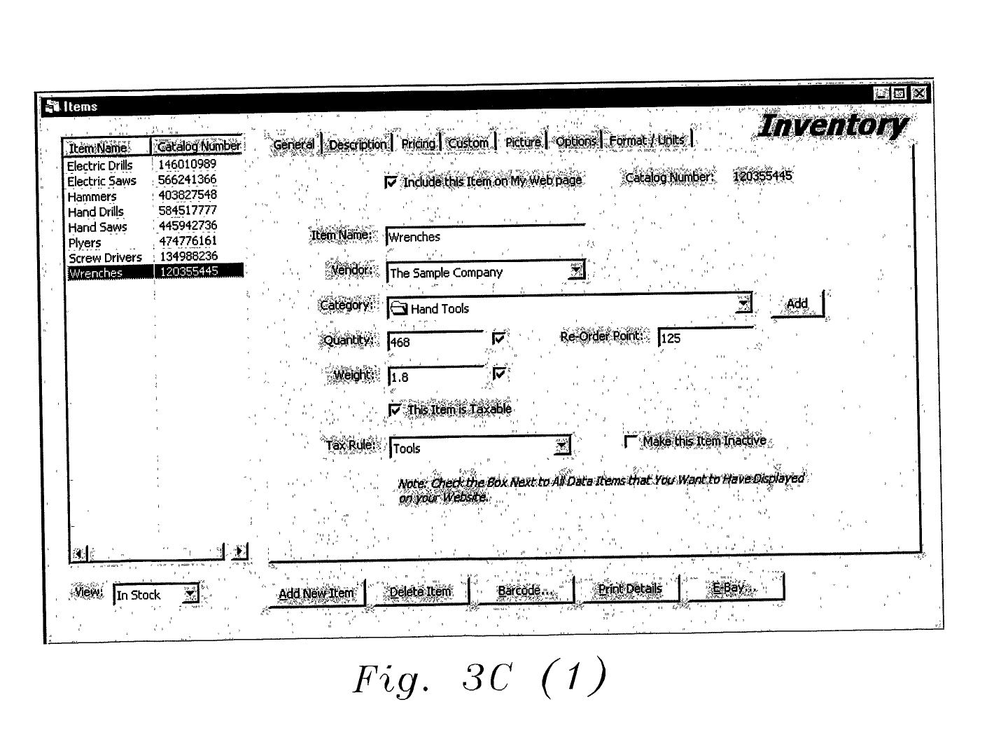

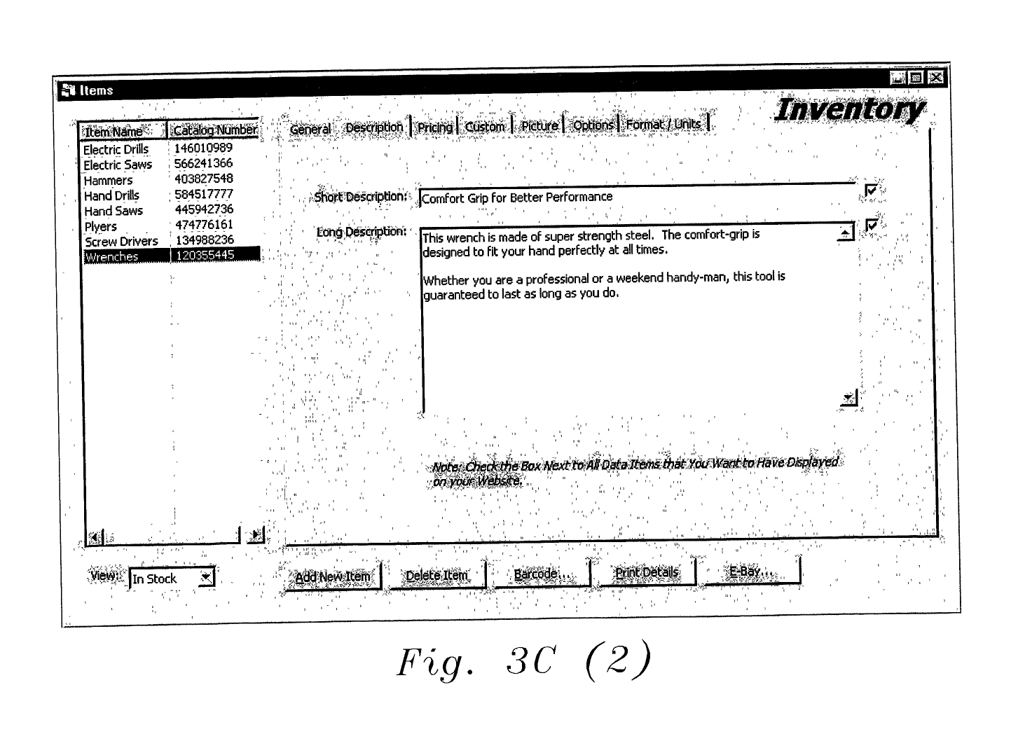

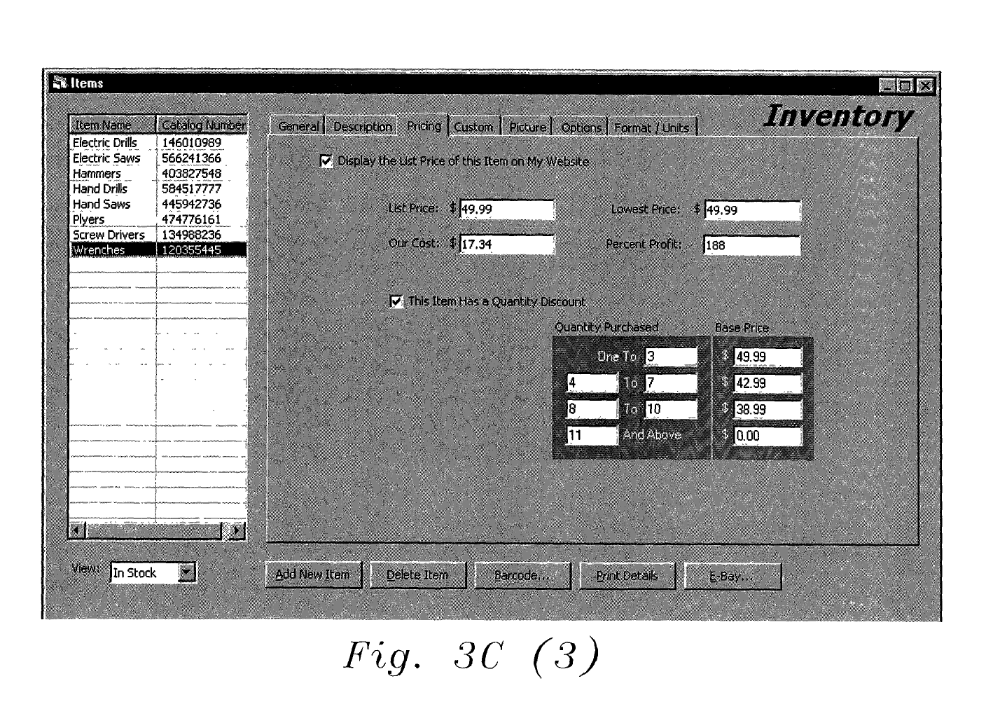

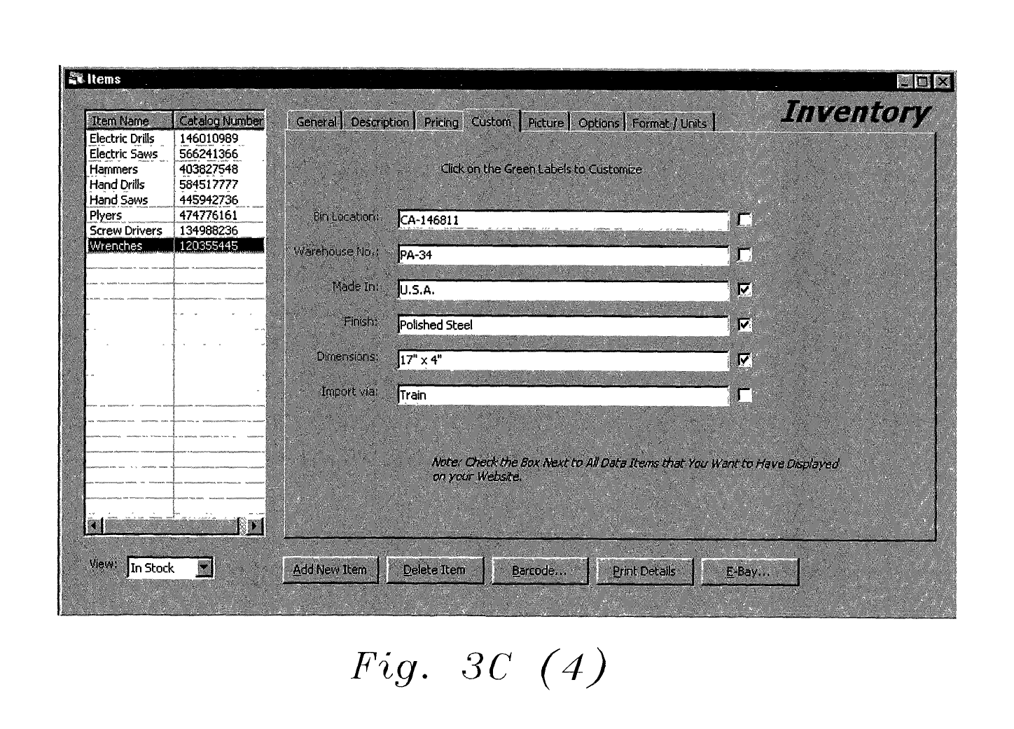

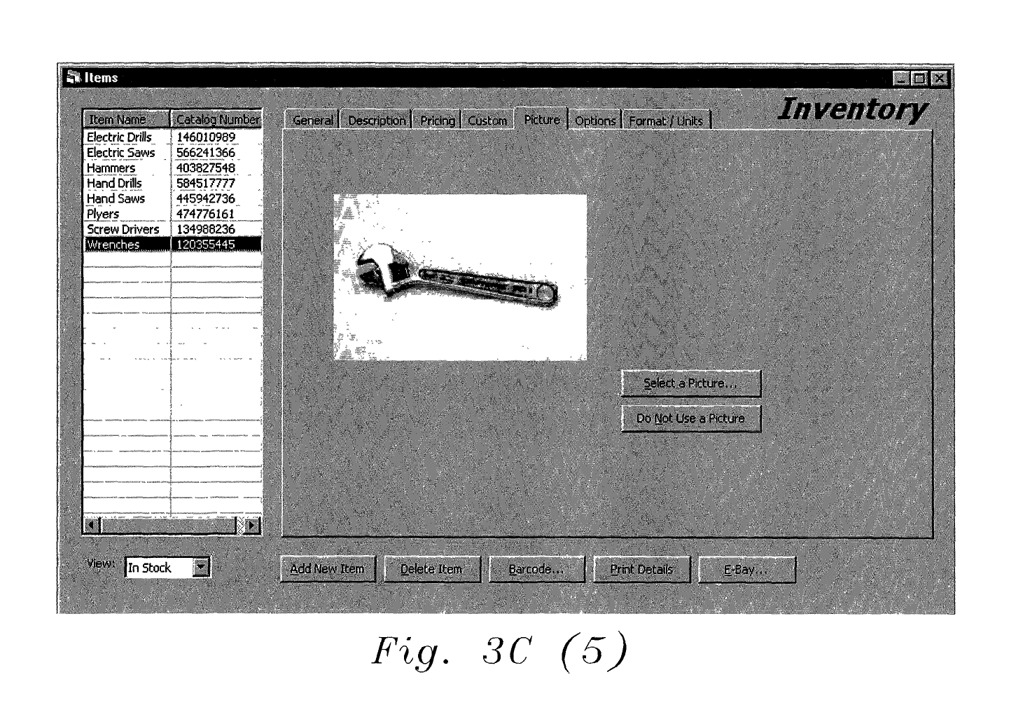

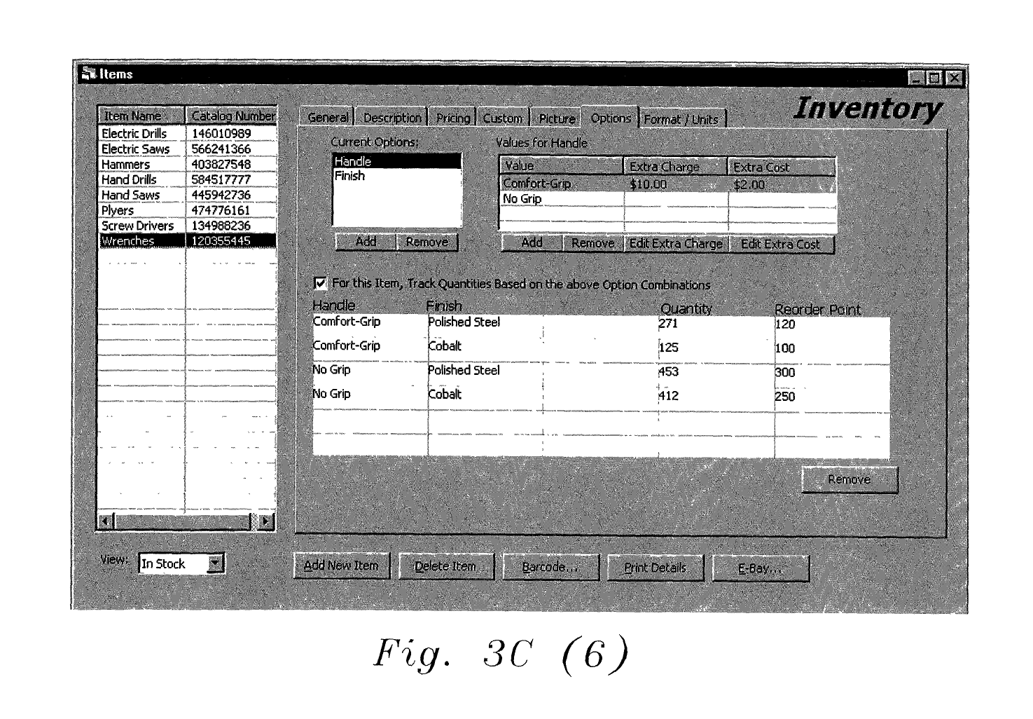

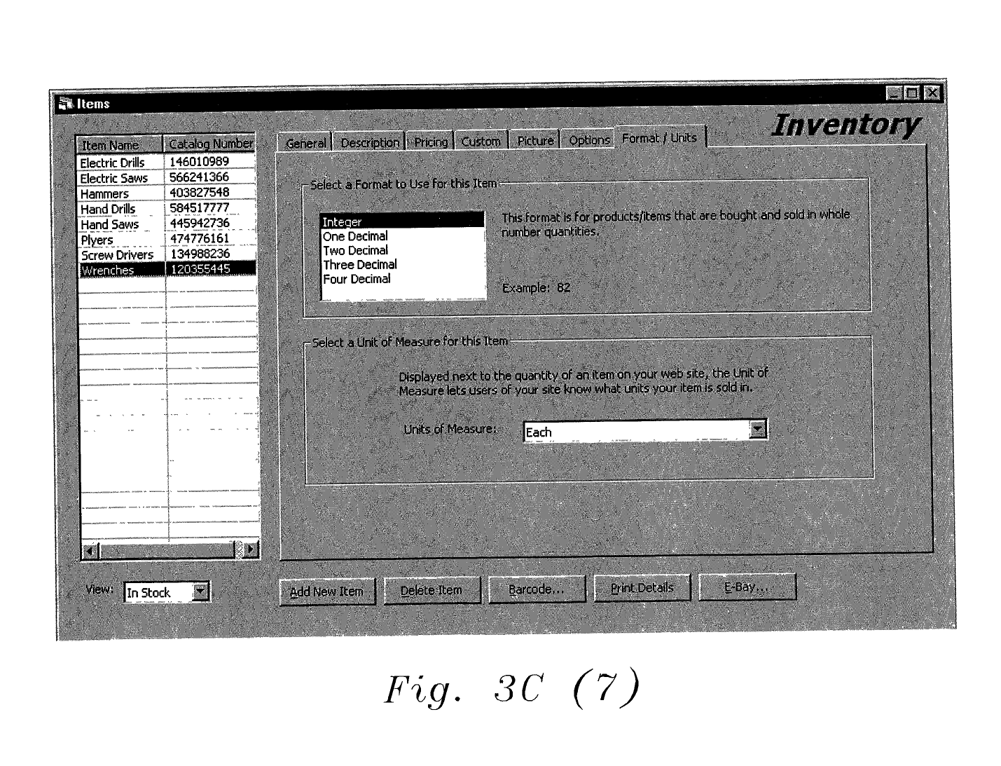

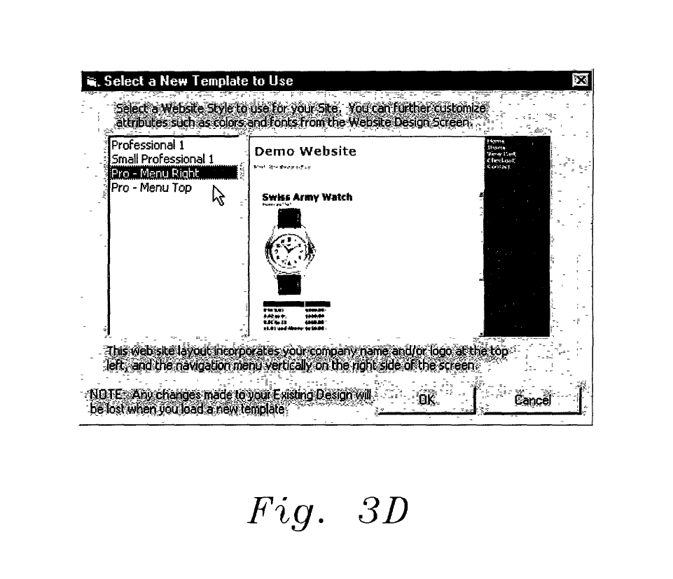

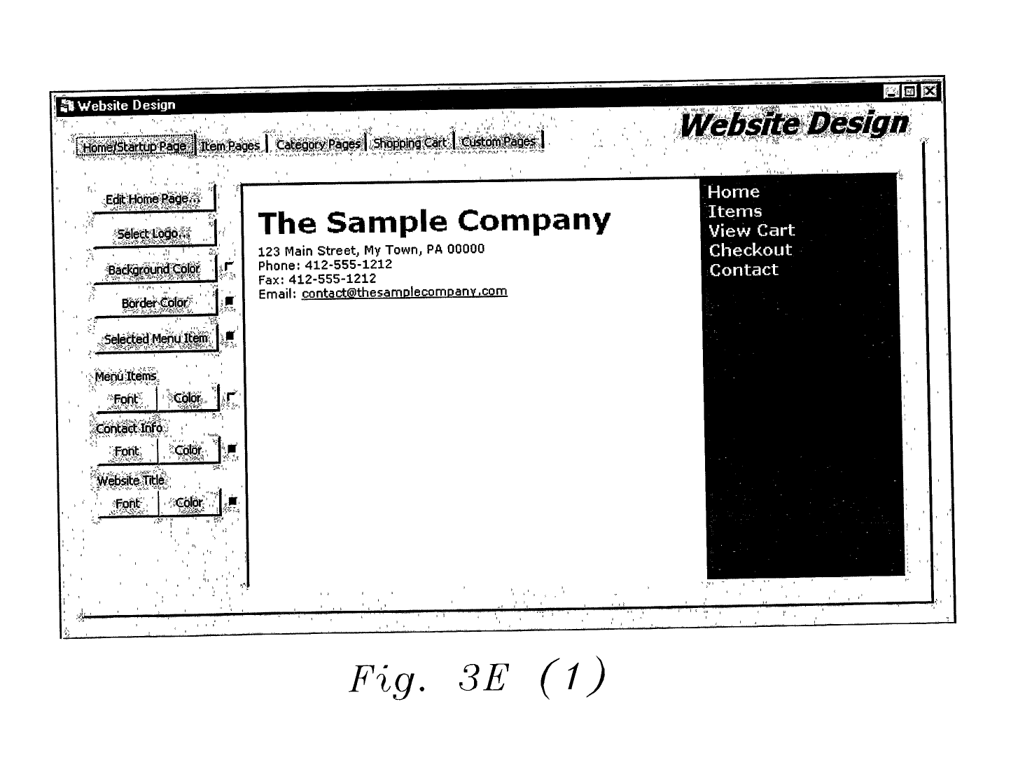

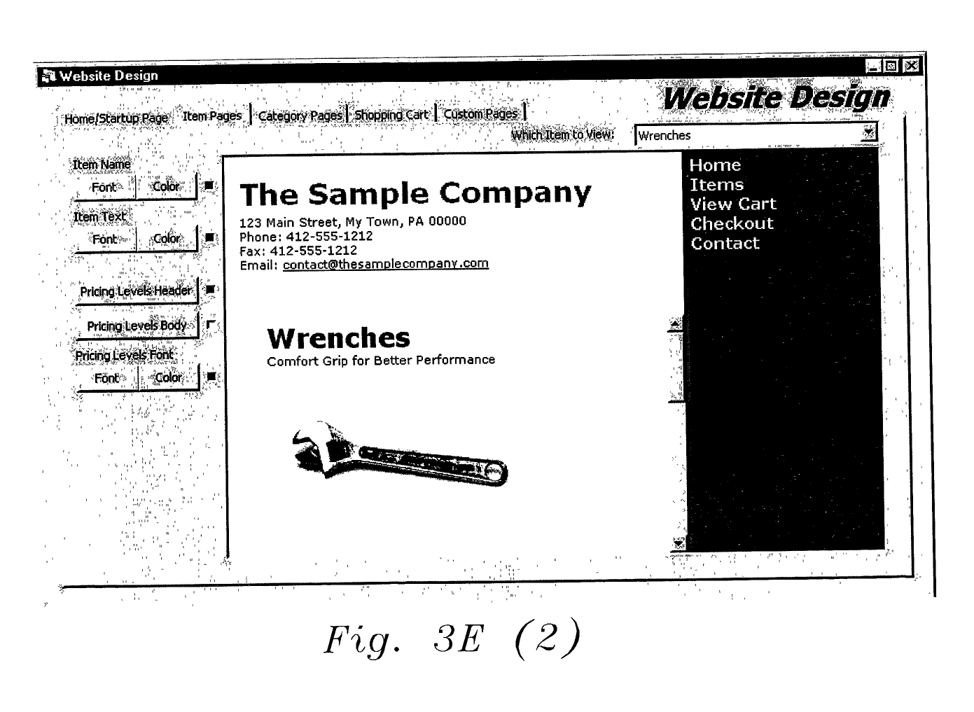

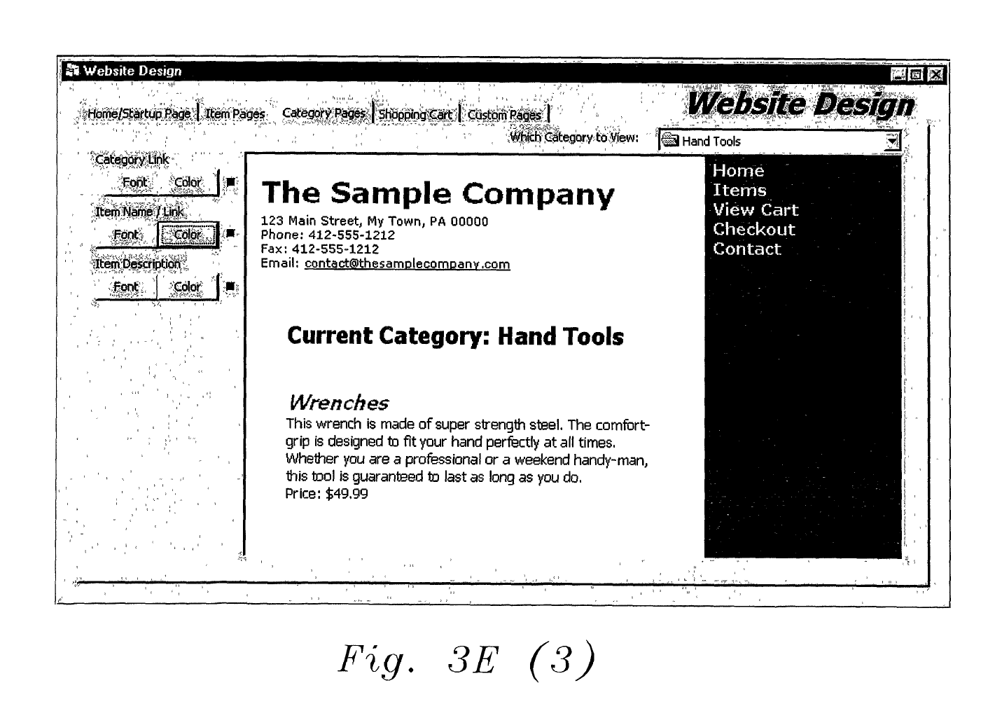

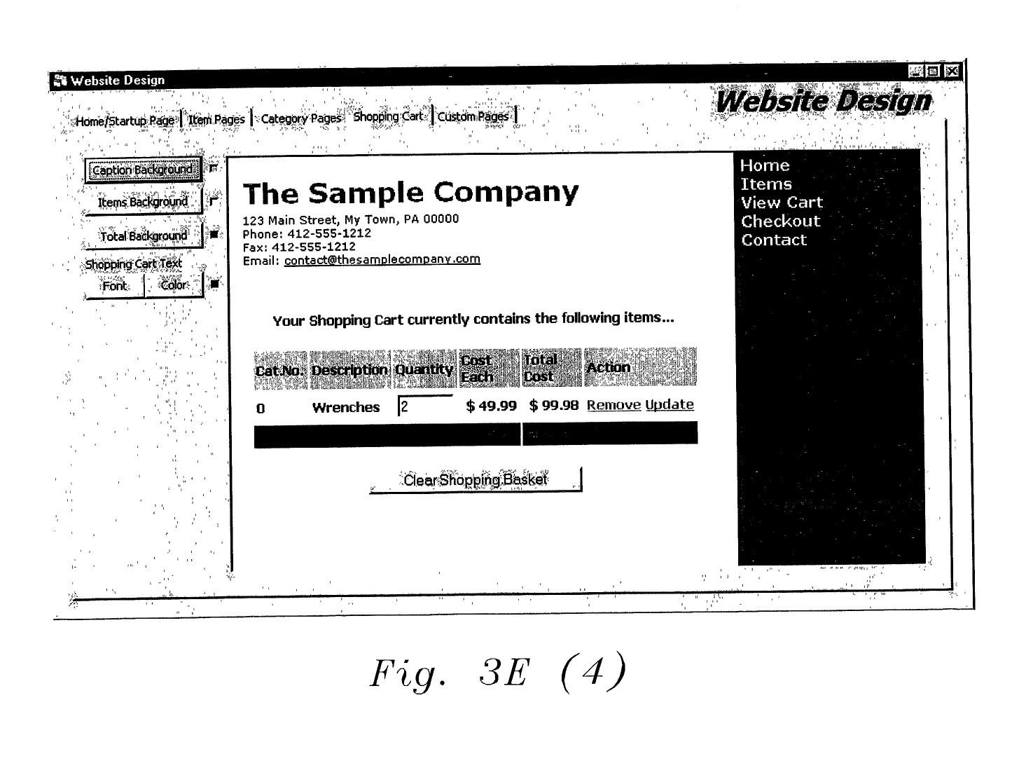

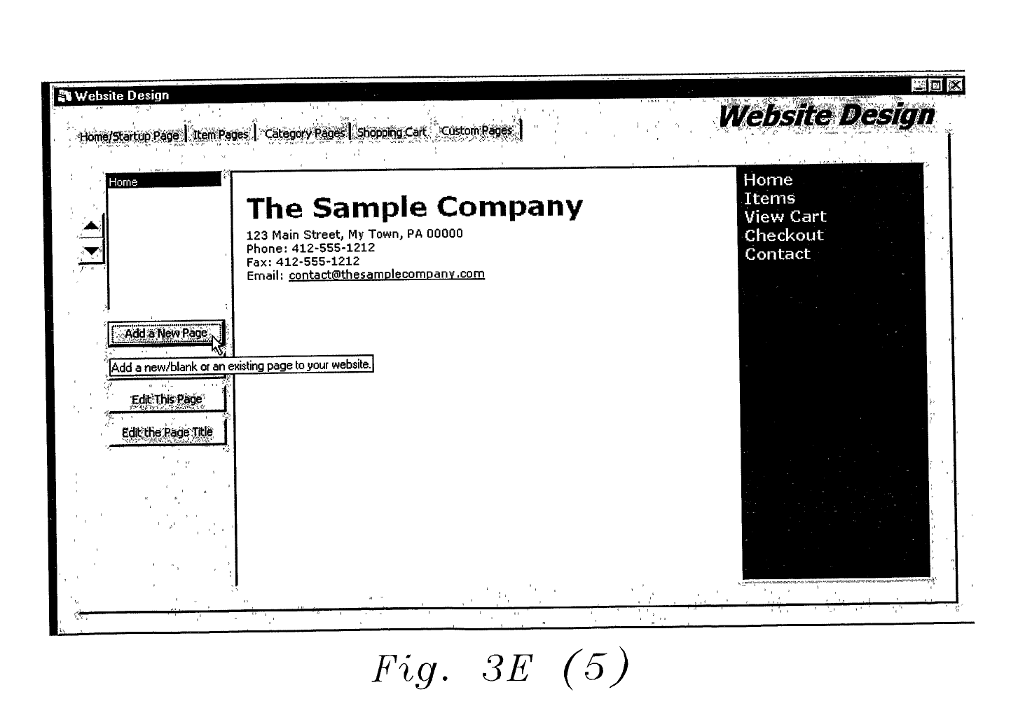

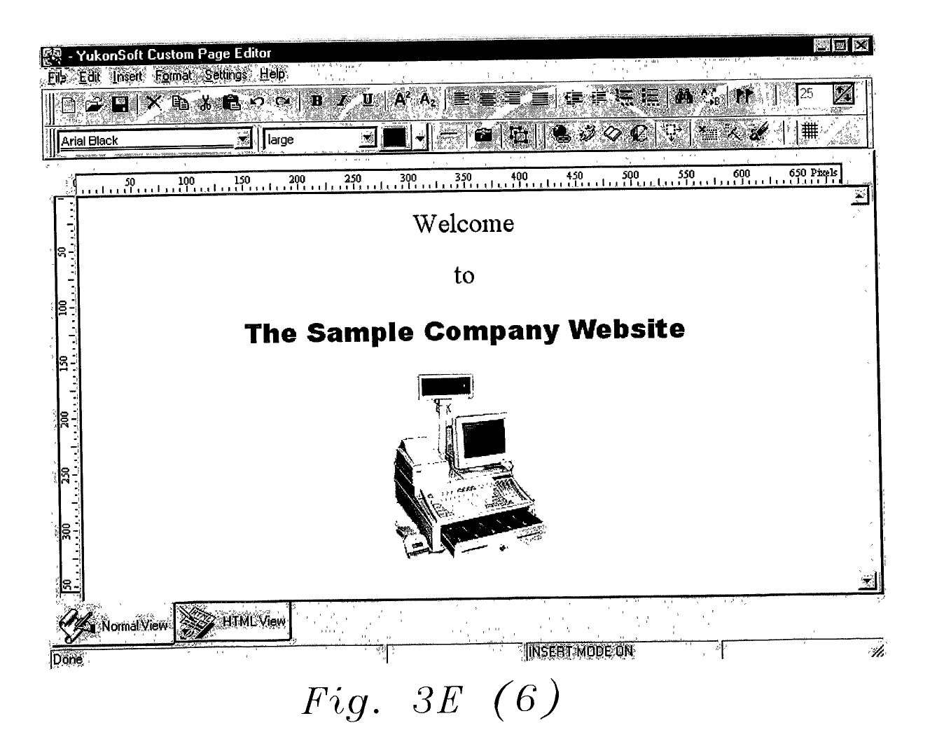

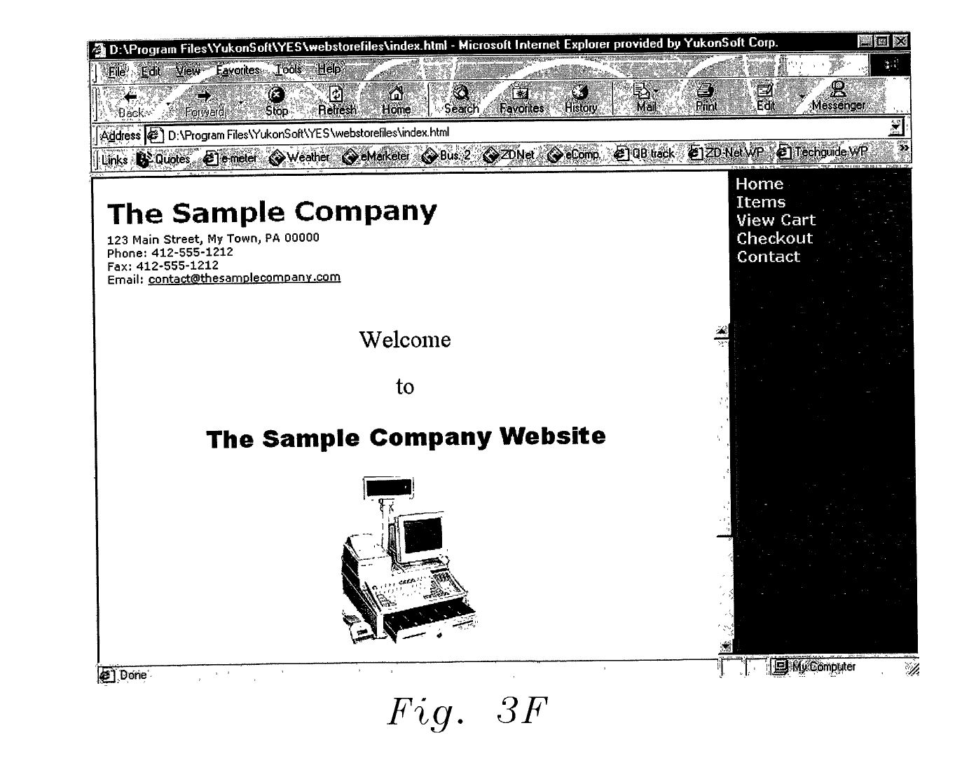

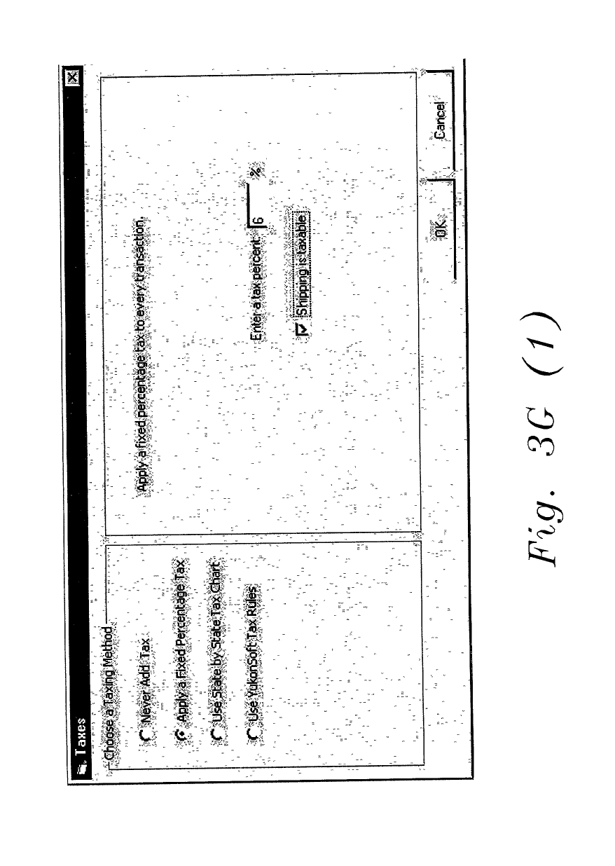

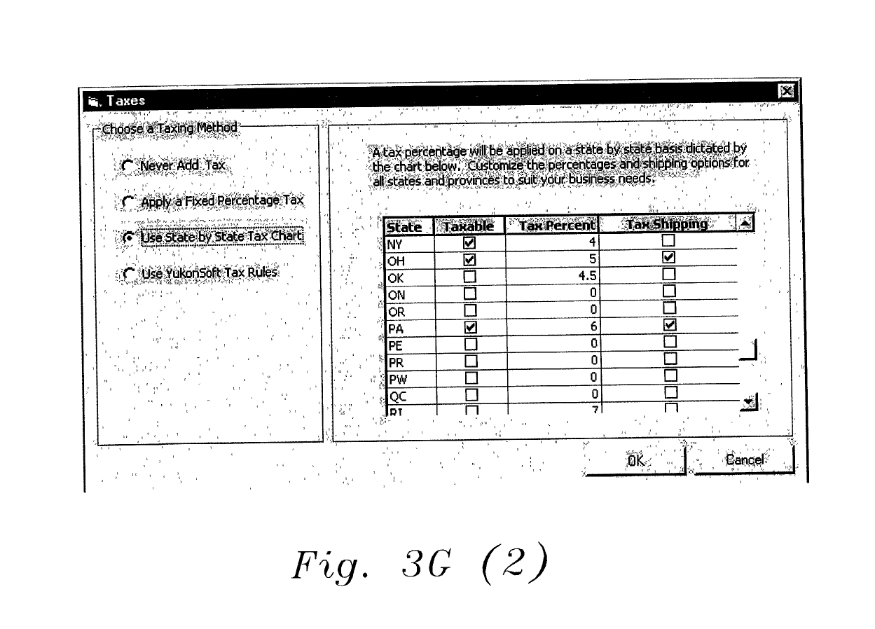

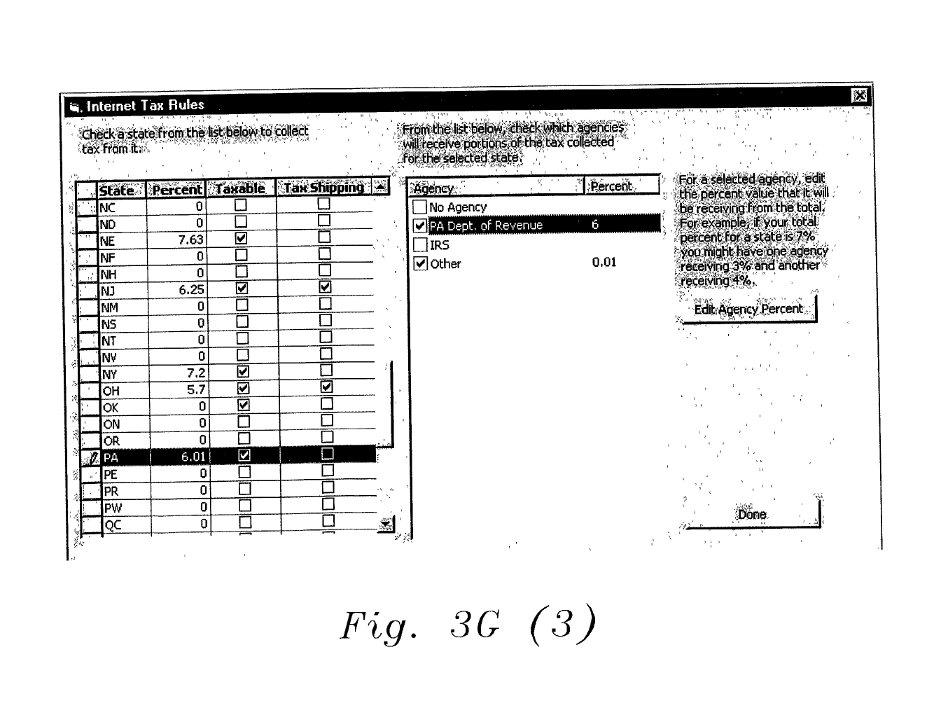

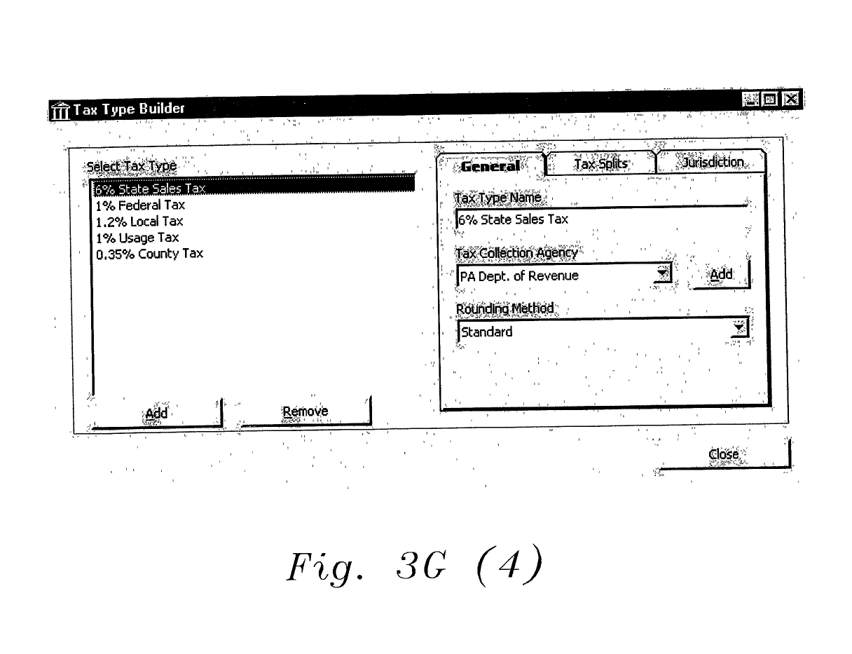

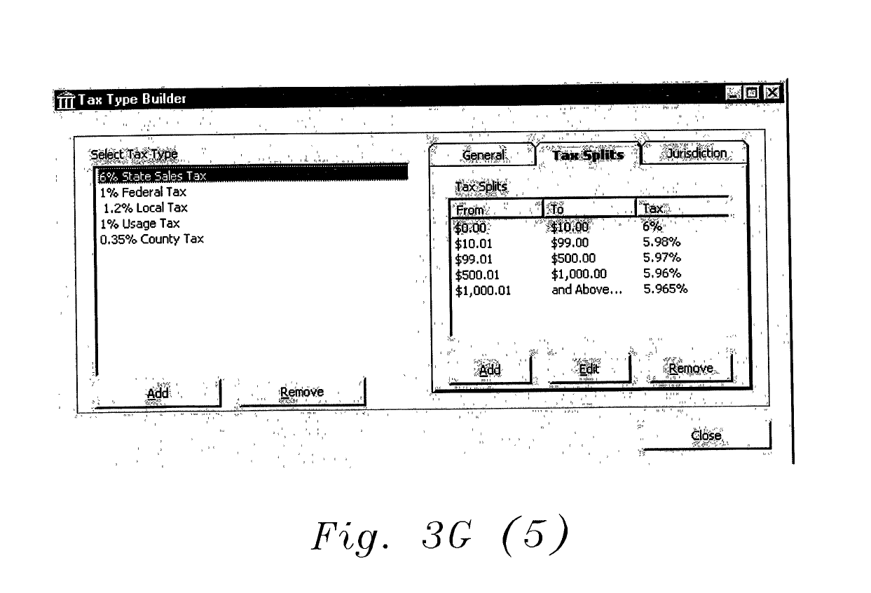

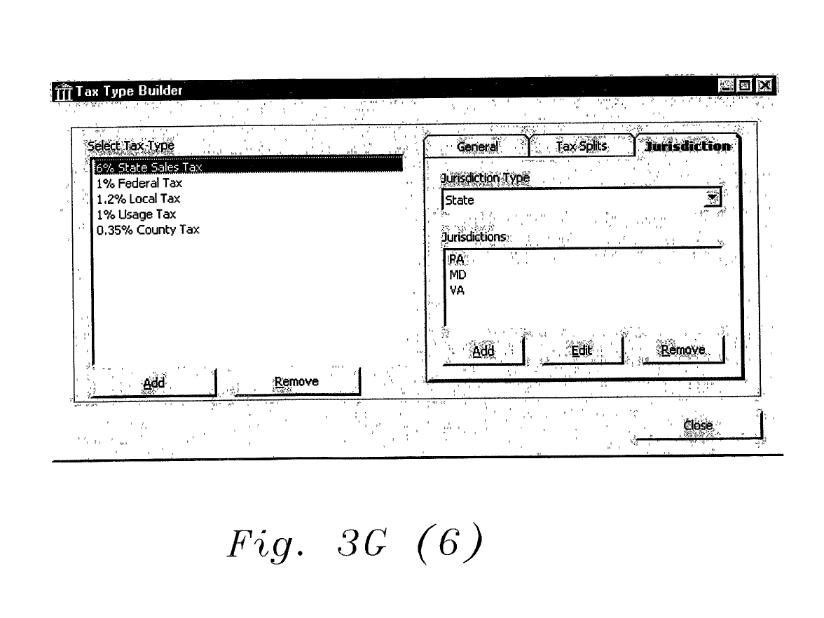

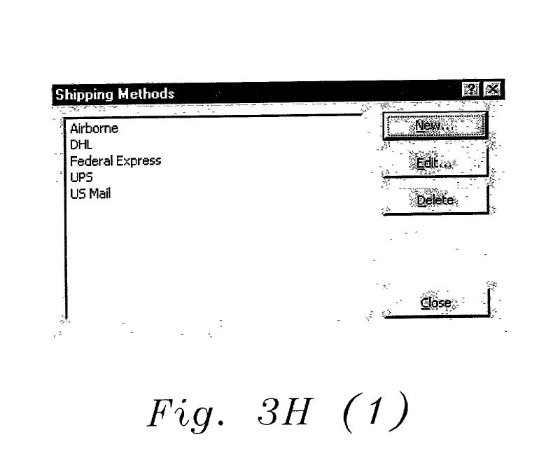

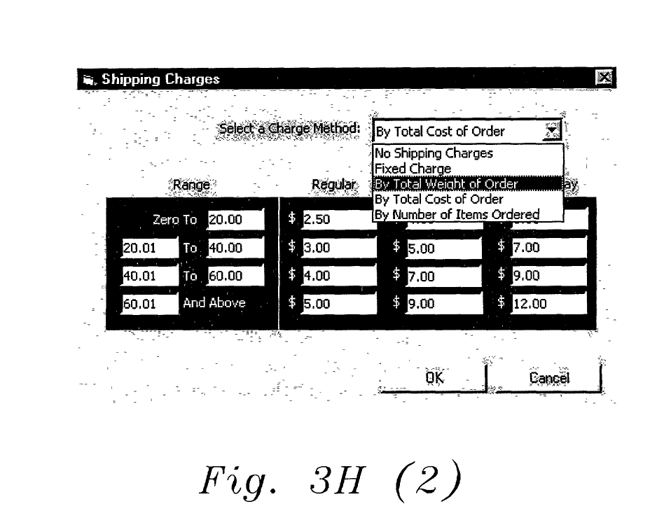

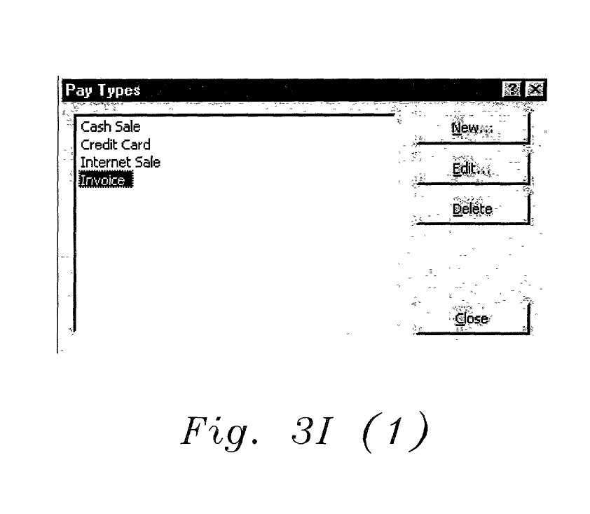

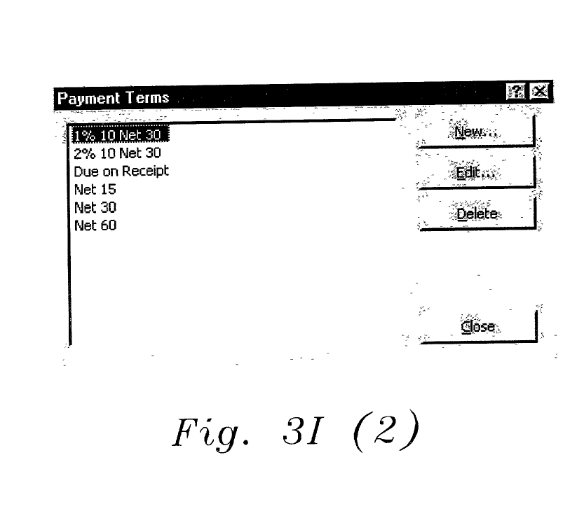

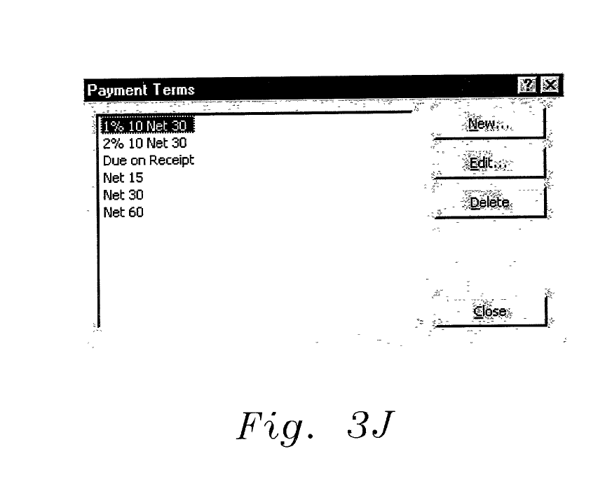

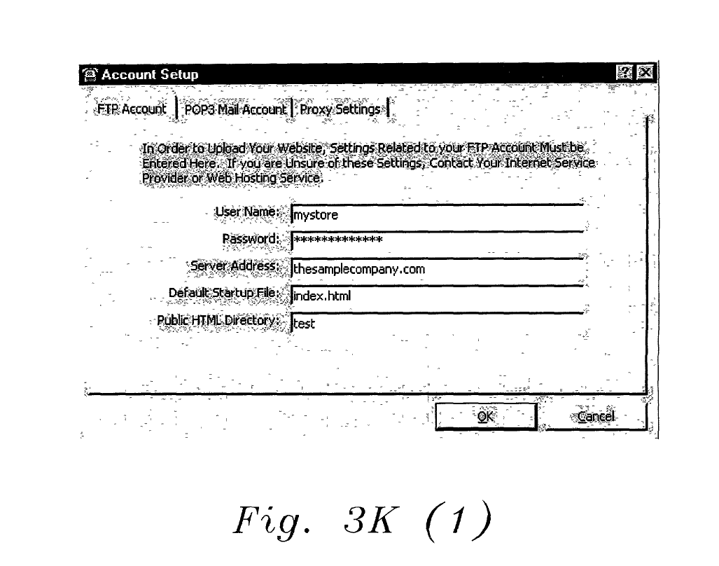

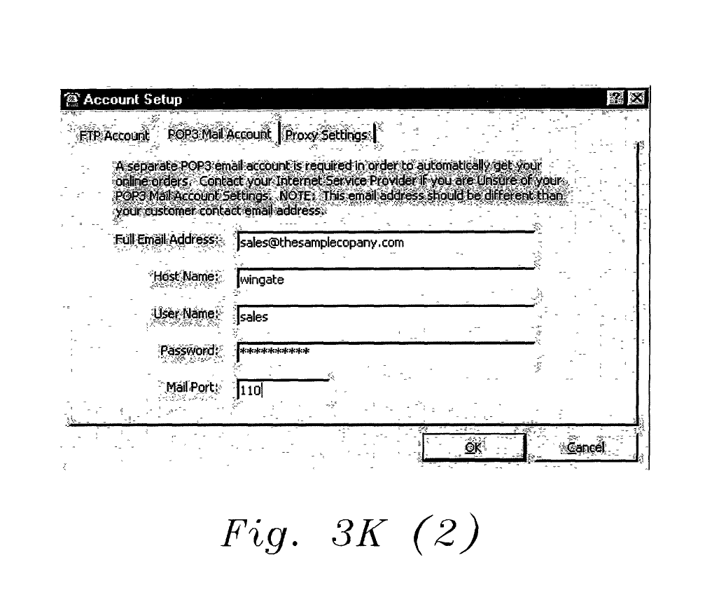

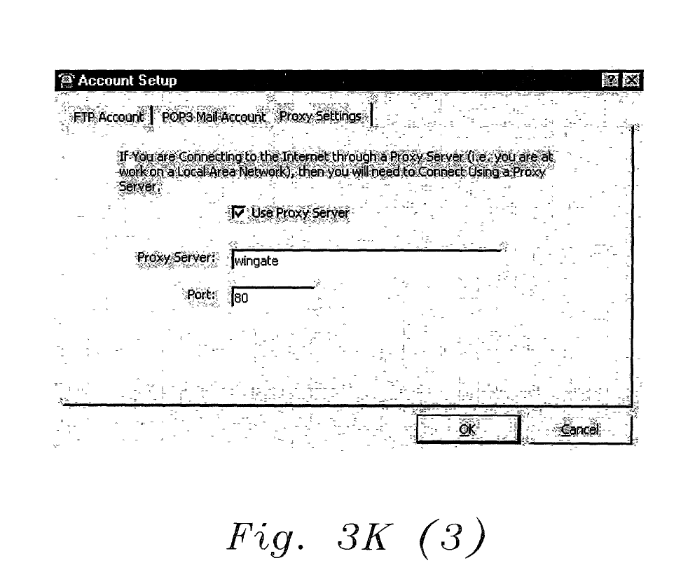

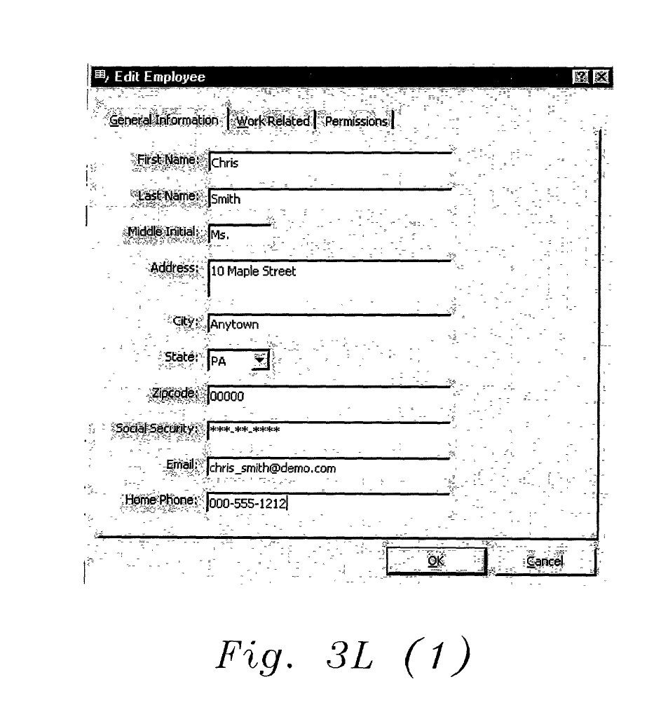

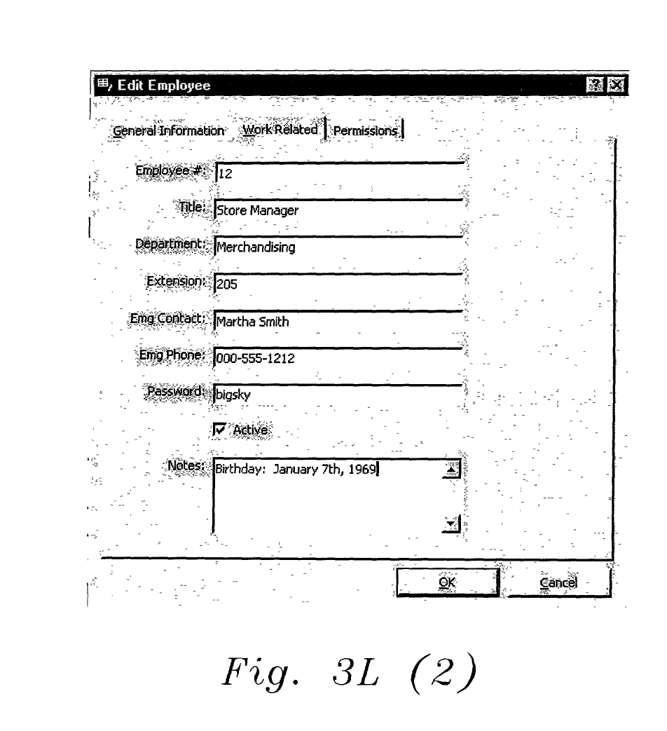

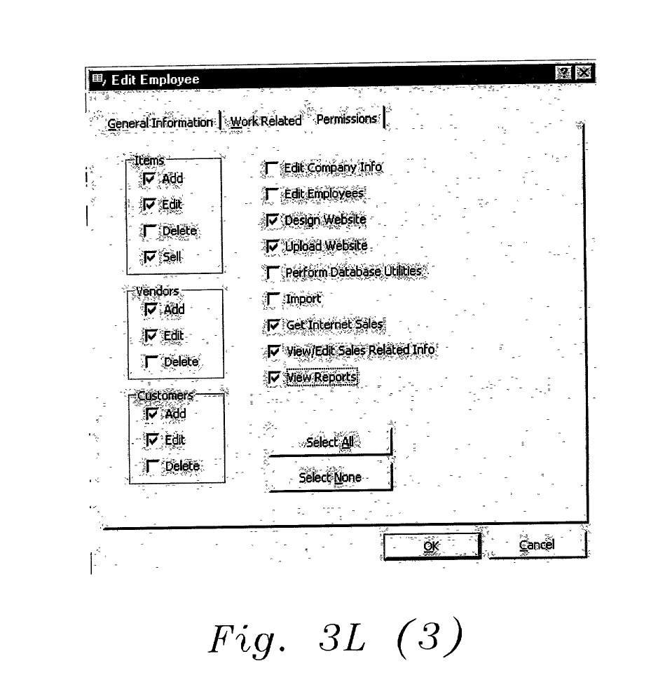

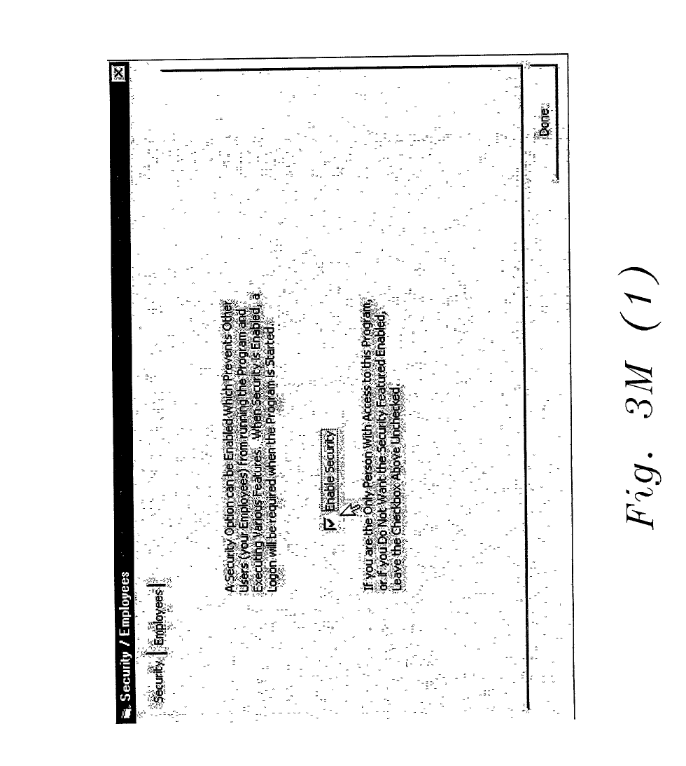

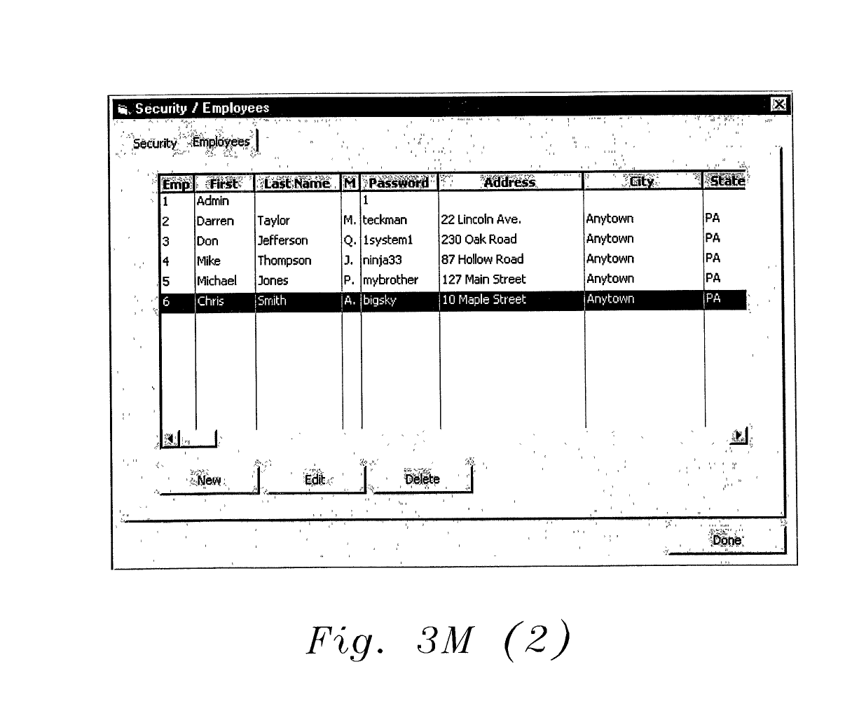

FIG. 3.1 shows the flow process of how the web creation features work, as well as how to customize the merchant's web site, including templates. The web creation approach is a template driven process for a merchant to design a customized eCommerce website using a base template and a word processor-like HTML editor for custom pages.

FIG. 3.2 shows a flow diagram of the complete process of the invention for a merchant to design a customized e-commerce website, enter (build) their inventory, establish taxing, shipping, and payment methods, as well as secure transaction and site host settings for their website.

FIG. 3A shows how the merchant can enter essential information about their business into the page. This includes the title or name of the website, the email address, and the domain name of the website.

FIG. 3B shows how to add contact information such as the merchants address and phone numbers. Individual pieces of contact information can be displayed on the merchant's web site by checking the box next to the item.

FIG. 3C (1-7) show the “Inventory” screens which allow the merchant to easily add and manage items in their inventory. The merchant can enter all general information for each product, such as vendors, quantities on hand and re-order points, short and long descriptions, assign a image for each item, track their costs, and establish bulk pricing levels/price break points. Also, the merchant can establish and elect to track their quantities based on selectable option combinations of each item.

FIG. 3D shows how the merchant can select a web site template. This template determines the initial look and feel of their site. There can be a vast array of templates to choose from, all with different feature layouts, backgrounds, borders, and menu bar positions and orientations.

FIG. 3E (1-6) are screens that the merchant completes in building and customizing their web site. The merchant has the ability to change the font size and color for all aspects of their web site. The merchant also has the ability to change all of the color schemes for the web site's backgrounds, borders, and menu. From the word processor-like HTML editor, the merchant has the ability to easily create new custom pages, or integrate existing pages into their web site.

FIG. 3F is an illustration of the completed website being previewed from the merchant's machine browser. The merchant has the ability to review all changes made to their web site as they will appear on the Internet before uploading to their website.

FIG. 3G (1-6) illustrates the Tax Rules section of the invention. As merchants are required to accurately track and report various taxes, the invention provides complete automation to this otherwise time consuming and error prone responsibility. The invention provides the merchant with the means to automatically calculate, collect, track and report all applicable taxes associated with each sale. With the optional Tax Rules module, merchants with complex taxing schedules have the flexibility to apply taxes as a fixed percentage of sale, on a state-by-state basis, or specifically designed for each item. The Tax Rules Builder enables the merchant to create and implement complex taxing rules for an item or group of items, detailing ranges of transactions and their corresponding taxes, and the specific agencies collecting the tax. The module then develops reports detailing the amount of taxes required to each agency

FIG. 3H (1-2) are illustrations depicting screens where the merchant establishes how to calculate and collect shipping charges for both online and in-store transactions. The merchant has the ability to establish methods and charges to be applied to shipping.

FIG. 3I (1-2) are illustrations depicting screens where the merchant establishes what methods and terms of payment they will accept for both online and in-store transactions. The merchant has the ability to establish the forms of payment as well as the acceptable terms of payment.

FIG. 3J is an illustration depicting a screen where the merchant establishes the means to accept secure payments for online transactions. From this screen, the merchant determines which methods of secure payment they wish to accept for the secure payment gateway provider.

FIG. 3K (1-3) are illustrations depicting screens where the merchant establishes their web site hosting settings, and email settings for receiving online orders. These screen enable the merchant to determine the specific settings for uploading their website to their web host provider, and the specifics of the email server they will access when retrieving new online sales.

FIGS. 3L (1-3) are illustrations of screens depicting detailed employee information, including data regarding just what information on the system they may access and control.

FIGS. 3M (1-2) are illustrations of screens showing a security-enable feature and a listing of employees having access to the system.

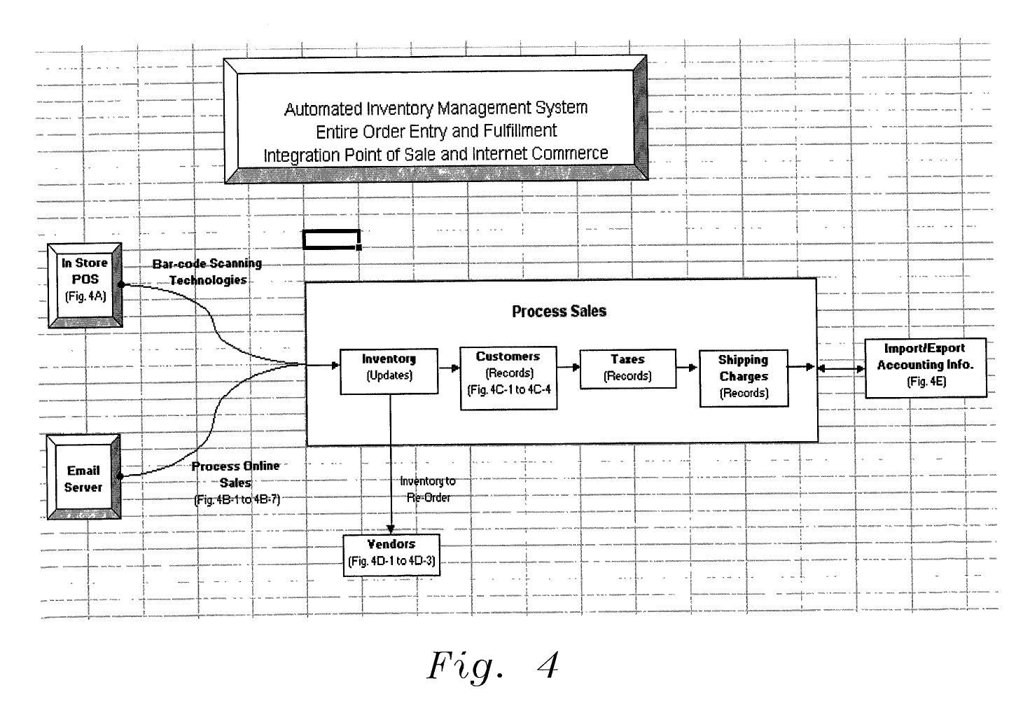

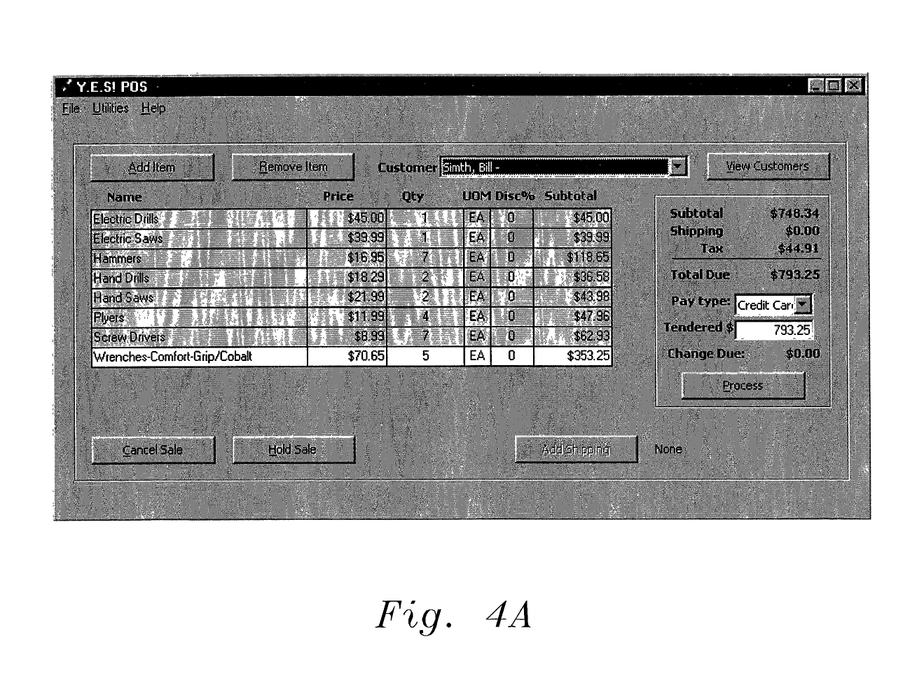

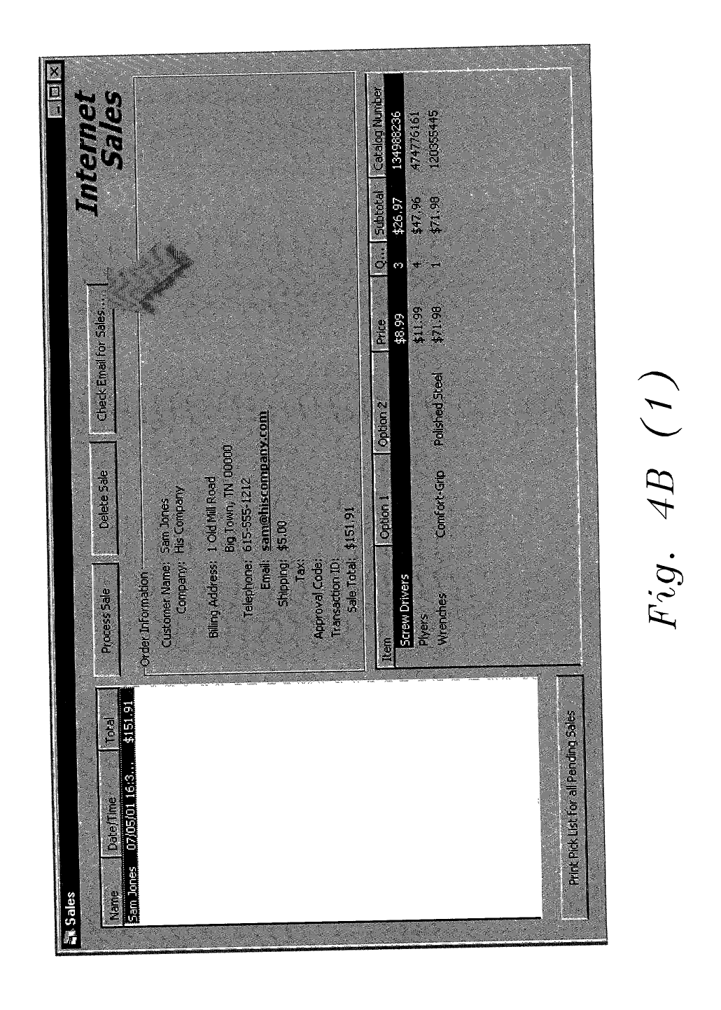

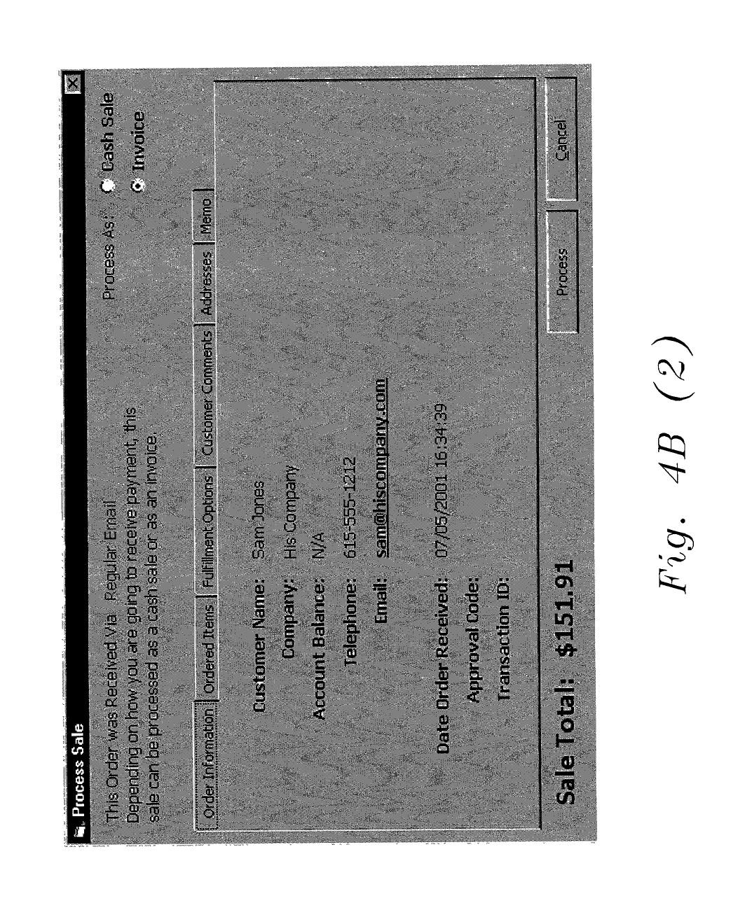

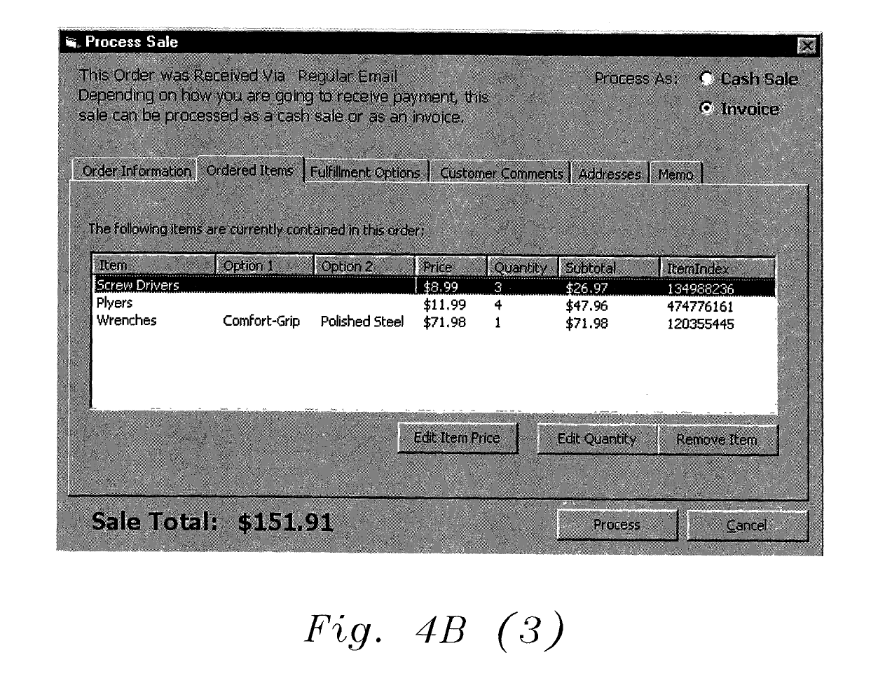

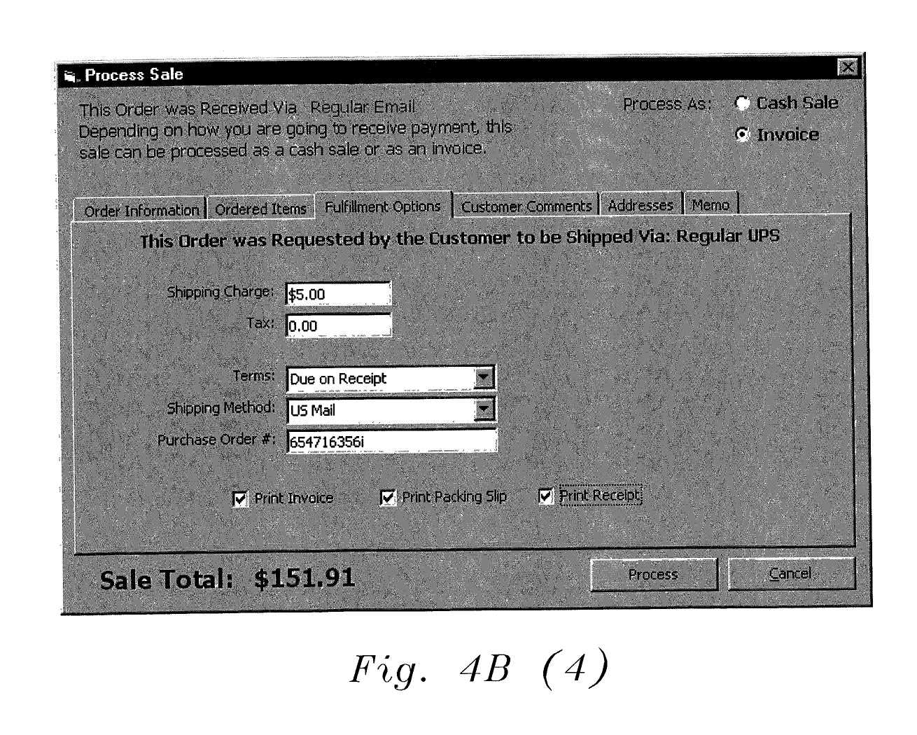

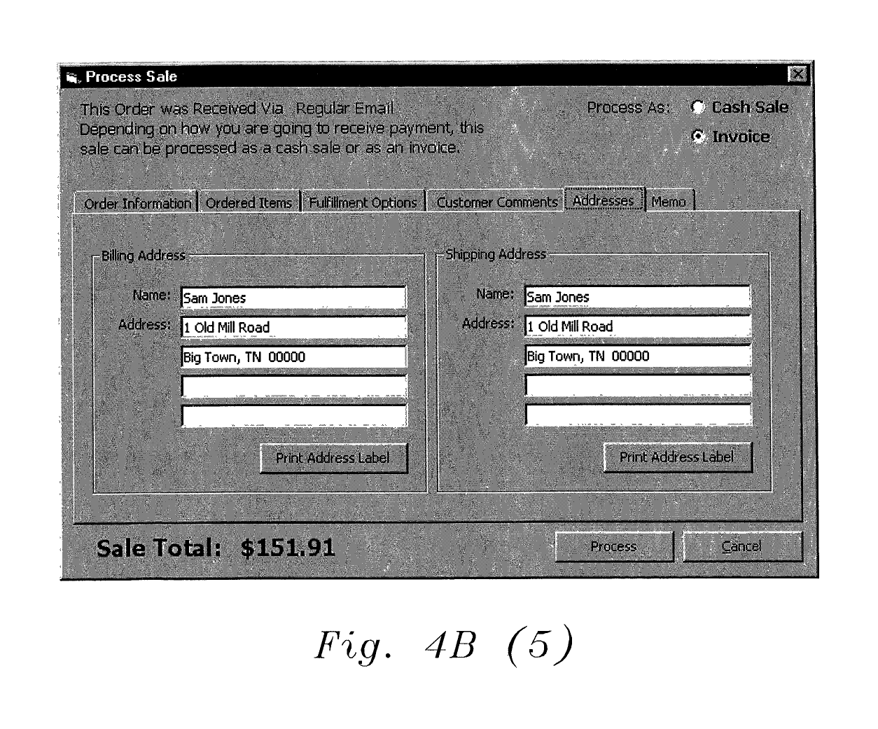

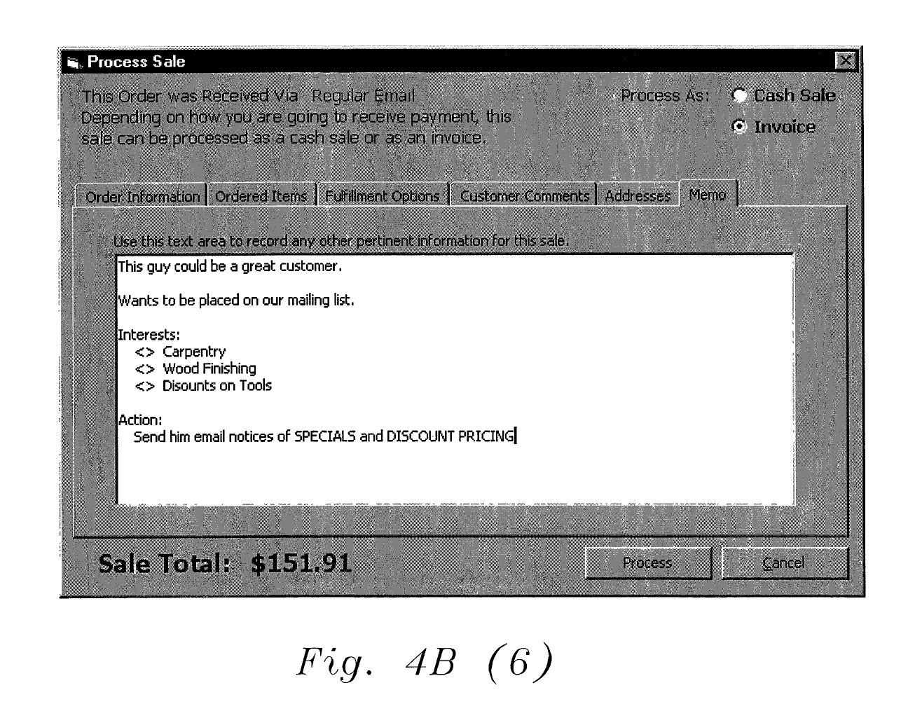

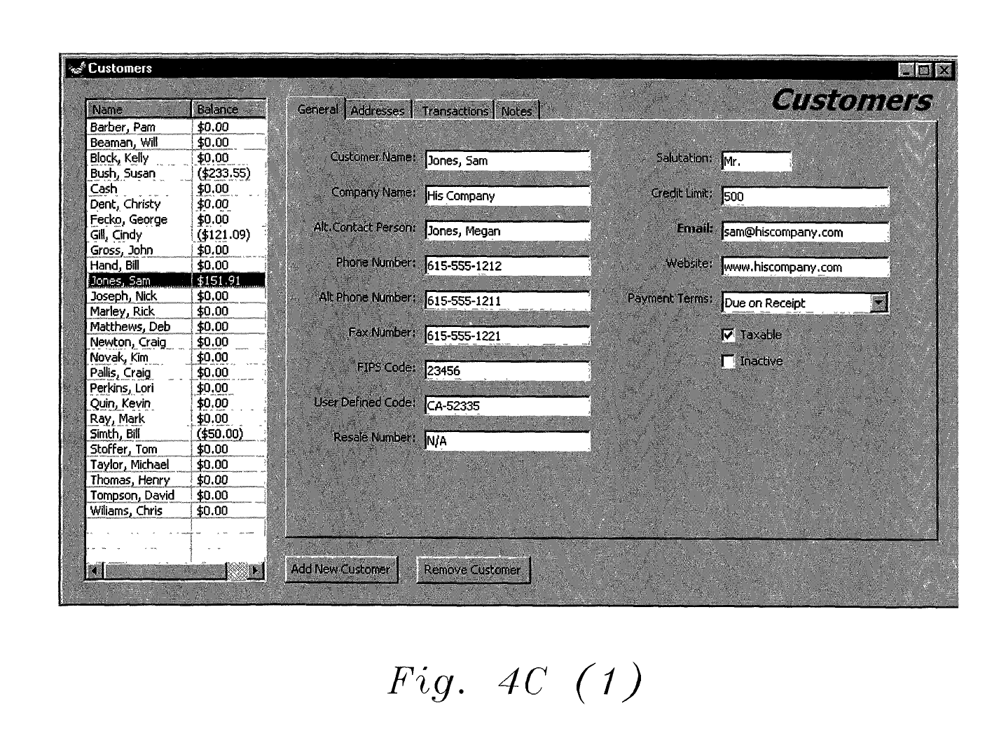

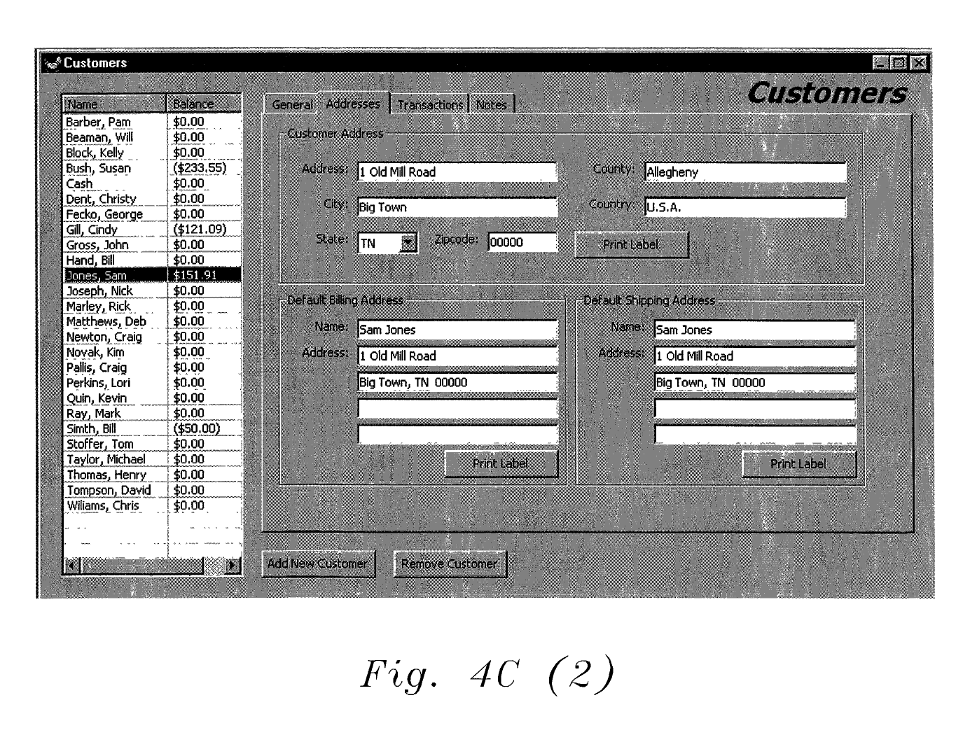

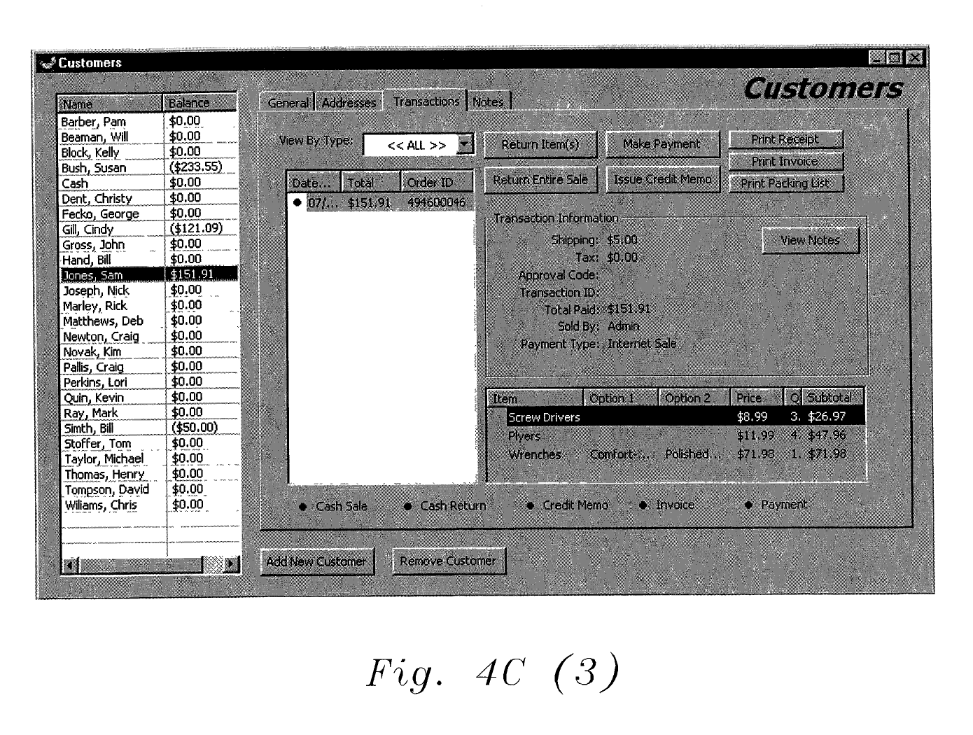

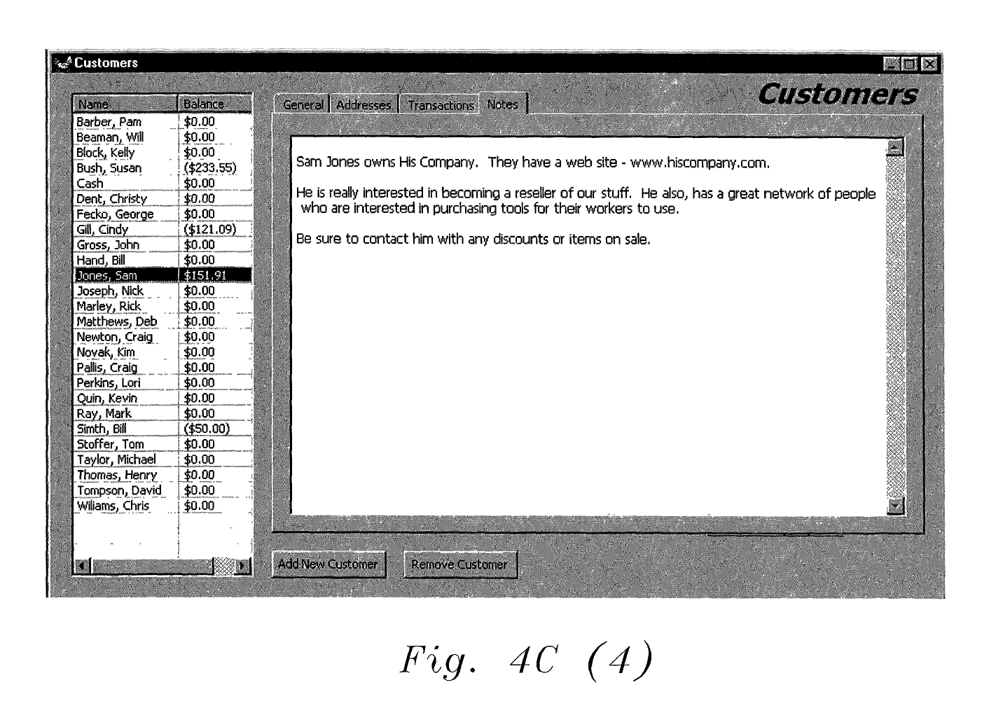

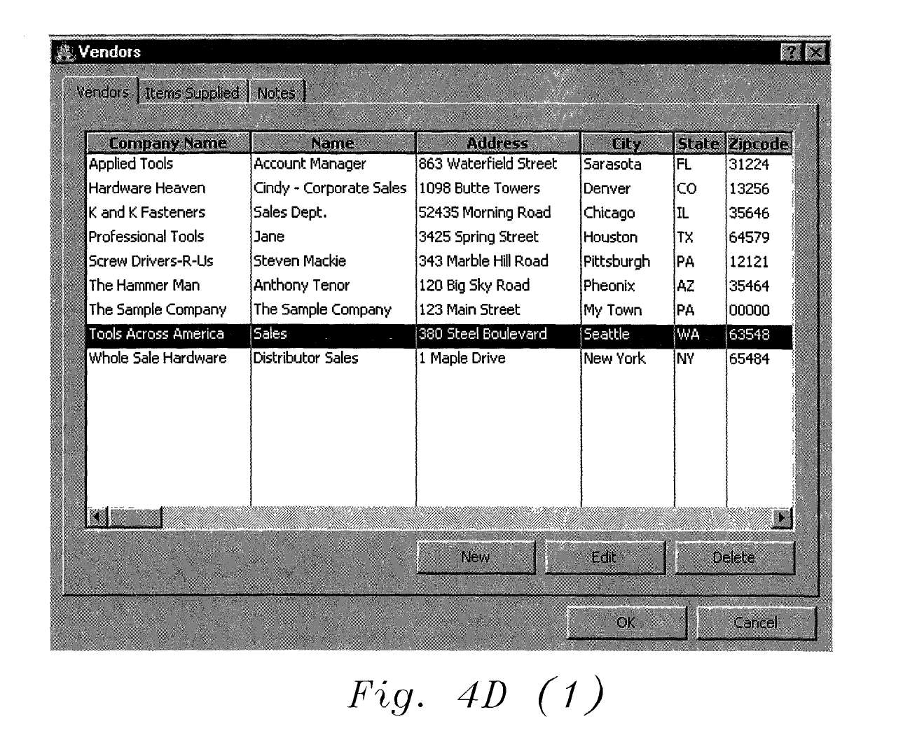

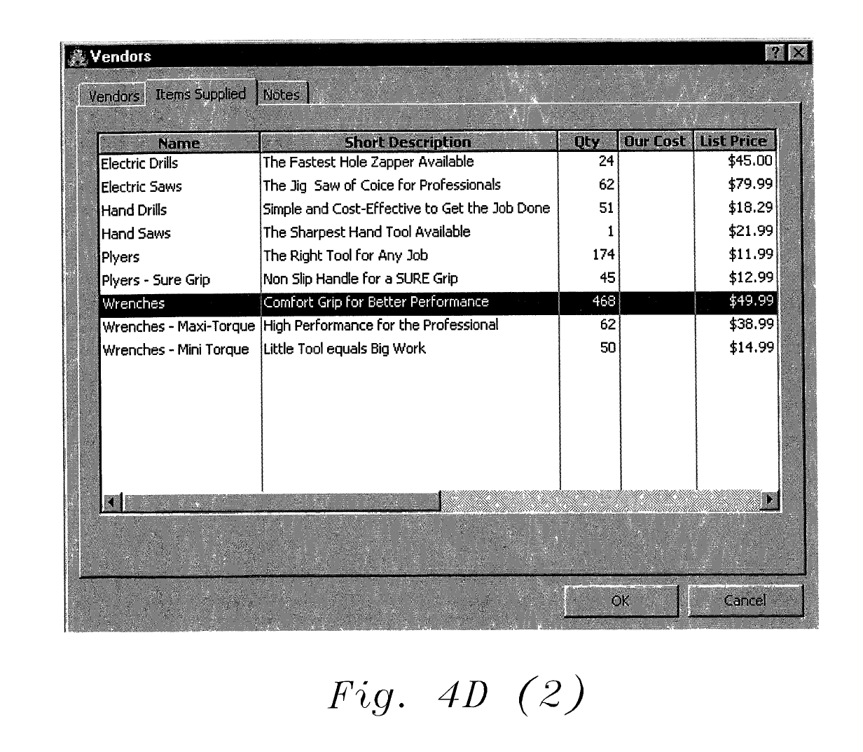

FIG. 4 shows a flow diagram of the business process for the simultaneous integration and management of the e-retailing and existing storefront operations for a merchant to have full desktop control of both the physical store and Internet store operations, without using any third party server-side applications to create and manage the Internet e-commerce web site. The client-side applications software of the instant invention allows the merchant to create and maintain both channels of distribution, i.e., sales on the web and sales in a physical store, on a stand-alone software residing and operating on the merchant's in store computer. Everything is managed locally, and, then, when the merchant accesses the Internet, through whatever means the merchant chooses, then the merchant can upload the information through conventional well known approaches such as transfer of inventory information from the store owner's computer to the store owner's web host's web server via the public Internet, using the File Transfer Protocol (FTP).

The “uploading” process involves communicating so as to transfer information (upload) from a client computer terminal (the merchant's computer) to another computer, usually a web server. The information to be transferred in this system is typically, but is not limited to, hypertext Mark-up Language (“HTML”) files and binary image files. Uploading is carried out by copying files, via the FTP protocol, from one computer to another computer over the Internet. One of the computers is usually a web server. When the “uploading” process to an Internet server is complete, the files are immediately available for viewing anywhere in the world via the Internet by any connected Internet Browser, such as Microsoft Internet Explorer or Netscape Navigator. Raw inventory information, that is the actual inventory database, is not uploaded to the Internet. Rather, the system dynamically generates HTML pages for Internet use that represent selected inventory items.

The system software is able to generate full or quick reports on expenses, profits, sales, customers, inventory and supplies. It may also manage company expenses and alert the owner to the inventory when supplies are low. The software is also equipped with shipping information including charges and taxes. Several options are available including whether or not to apply tax, which may be based on the customer's state of residence, and whether or not to charge for shipping which may be based on quantity, weight or amount spent.

FIG. 4A is an illustration depicting a screen showing the full featured integrated point-of-sale system, which integrates in-store purchases with online purchases. The user interface is simple and effective, which means making a sale in the merchant's store is fast and easy-using a mouse or a few simple keystrokes. Additional features include easily trackable online customer information, and payment options which can include, cash, credit card, credit, or other means of payment. In addition, invoices and credit memos are easily created for each customer. Based on merchant-defined criteria, any shipping charges and sales taxes are automatically calculated and applied to both online and in-store sales. To minimize key or mouse strokes, the invention also has capabilities to use other input devices, such as bar code scanners for easy point-of-sale transactions and controlling inventory.

FIGS. 4B (1-6) are illustrations depicting inventory control screens enabling a merchant to sell items online and from the merchant's store, from the same inventory. The inventory screens give the merchant access to all pertinent information on each item in inventory. Because items sold via the Internet and in their retail store come from the same inventory, controlling inventory levels is possible. From general item information, pricing information, to barcoding and quantity tracking and other customizable fields, all information is readily available. Additionally, an image file (.jpg, .jpeg, .jif) can be associated with each item for display on the merchant's website. Complete reporting capabilities are also available. With a click of the mouse, the merchant is able to view current inventory levels, profit levels, online sales, in-store tax reports, and various other reports.

FIGS. 4C (1-4) are the customer tracking and management screen. All customer information is automatically recorded and tracked for the merchant's convenience. Whether the customer purchased online or in the store, all customer information is easily accessible from the screens. A merchant can quickly and easily see details about a customer's contact information, purchasing history, trends, outstanding balances and much more. From the customer screens, the merchant can complete payments, issue credit memos, or do returns, saving the merchant valuable time.

FIGS. 4D (1-4) show the inventory and vendor tracking features of the invention. The invention automatically tracks vendors, the products they supply, and quantities on hand, making inventory control simple. The merchant can view each vendor's contact information, items supplied, prices the merchant pays for each item, and the merchant's percentage of profit made from the sale at their list price. Having control over the inventory they receive from vendors helps the merchants focus less time on chasing inventory to stock, and more towards building their business.

FIG. 4E shows the Import-Export Screen, where information can be shared from this invention between other third party software products.

FIGS. 5A and 5B show block diagrams of the method for indexing and managing the web site generated by the store owner and uploaded to a typical community website, as contemplated by the invention, using an existing search engine such as the major search engines currently available on the Web. In essence, the store owner builds and maintains all of the elements which make up their website on their desktop computer, without having to access any third party applications offered by its web host's web server or otherwise. Using the software of the instant invention, the merchant can generate the code and upload it to the community website. Existing major search engines will be able to access the information maintained on the merchant's site, which can be viewed by a prospective customer.

This process begins with the merchant inputting and customizing the e-commerce site. After the site has been uploaded the factual data from site is retrieved (“harvested”) by existing search engines. This is a continuous process. After downloading the latest information, the engines process the data and store it indexed against the engine's indices. A user logs into the Web and accesses the search engine. The user enters a search query, and if there is a match, the search engine builds page to provide links to relevant e-commerce sites. Now the user can select sites, and enter the e-commerce site to make purchases, or discern further information. When finished the user can begin another search, or look at the remaining matches.

FIGS. 6A and 6B show block diagrams of the method for indexing and managing the information generated by the store owner and uploaded to a typical community website, as contemplated by the invention, using a community search engine designed to be used with the system of the invention.

The method for indexing and managing a searchable community of non-HTML information utilizes an electronic search engine which indexes data files used by sites created by the website generation software of the invention. The indexing process of the search engine indexes HTML and non-HTML information from websites enrolled in an electronic community. The non-HTML data includes a database from which enrolled websites operate. This information is downloaded over HTTP, parsed, and indexed with unique parameters into a database running on the search engine. The search portion of the search engine process operates like standard search engines. A user submits a request over HTTP to the search engine. The search engine processes the search request and presents the results to the user in a dynamically created HTML page. A feature of this portion of the process is that the links to the search results are constructed with the necessary parameters to allow the target websites to be hyperlinked, with the appropriate dynamic content being shown.

The method for indexing and managing a searchable elctronic community of web site information is utilized in conjunction with an electronic community. The “electronic commerce community” is defined as a group or groups of online businesses constructed by similar software (specifically the one disclosed herein) and administered by a main electronic commerce site. The electronic community is specifically a group of electronic retail storefronts created by electronic commerce software to have similar architecture and design. The electronic storefronts can have inventory available for search in real time so that items are not ordered that are out of stock. The search engine provides consumers with the ability to organize items and retailers by category and search for specific merchandise. The search can be conducted using multiple word forms, space delineated forms, and boolean operators. Entries returned to the customer by the engine provide information on the items and links to the storefronts where they are available. The search engine gives registered customers the option to give feedback and ratings to the storefronts which is then displayed to provide confidence in the site. The search engine is also capable of displaying banners of advertisements, sales, and specials from information given by the owners.

The search engine is specially formatted to deal with a group of similarly created and managed electronic commerce web sites. The search engine gives merchants the ability to advertise and promote specific items or groups of items on a main search site to promote sales. Such a search site may include banners of featured items with descriptions from different web stores as well as links to those sites. Additionally a links page may be included to display a list of pertinent related sites. The search engine also provides consumers with the ability to browse possible retail sites by categories defined by the owner of the sites. Similarly items from multiple retail sites can be accessed and displayed by category with information from the their associated sites.

The search engine is able to handle queries in multiple word forms, space delineated forms, and using boolean operators. The engine searches all existing on-line stores within the retail group for the word or phrase requested and displays an associated item when found. Items returned by the search engine are categorized by the owner's site and include hyperlinks to reach these sites. These hyperlinks lead directly to the item on the owner's website and may open up a new window of the web browser.

Customers visiting the website may give feedback in the form of comments and a rating system. Such comments and rating may be viewed by the owner as well as future visitors to the site to provide a level of confidence in the site. Feedback may only be given by registered customers to protect against unprovoked or malicious responses. Such a registration includes personal information and an electronic mail address which may be used as the unique login to the system.

The store owner builds and maintains all of the components which make up a website on their desktop computer, without having to access any third party applications offered by its web host's web server or otherwise. Using the software of the instant invention, the merchant can generate the code and upload it to the community website. A community search engine will be able to access the information maintained on the merchant's site, which can be viewed by a prospective customer, thereby allowing merchants greater accessibility to a larger potential client base.

This process begins with the merchant inputting and customizing their merchant e-commerce web site. The software uploads merchant's web site information that enables the site to be indexed by a capable electronic commerce community search engine. The search engine indexes the data files used by sites created with the website generation features of the program.

The following are the top level steps in this process:

1. Enrollment—A new online store created with the software submits a request to the search engine during the upload process of the website. An auto enrollment feature allows the website to be instantly ‘recognized’ by the search engine as soon as it is present on the Web. The enrollment process facilitates the creation of such ‘community’ or ‘local’ search engines, enabling resellers, ISPs, and other organizations can license and operate their own customized version of the search engine.

2. Indexing—The indexing process of the search engine indexes HTML and non-HTML information from the enrolled websites. The non-HTML data consists of the database from which the websites operate. This information is downloaded over HTTP, parsed, and indexed with specified parameters into a database running on the search engine.

3. Searching—The search portion of the search engine process operates like a standard search engines. A user submits a request over HTTP to the search engine. The search engine processes the search request and presents the results to the user in a dynamically created HTML page. A feature of this portion of the community search process is that the links to the search results are constructed with the necessary parameters to allow the target websites to be hyperlinked, with the appropriate dynamic content being shown.

4. Viewing—The viewing portion of the process allows the user to view the search results, and link to a new website. This viewing process is enhanced by specified parameters passed by the search engine to the store that generates the non-HTML page. search engines that searches/finds and indexes Internet store/site information that is non-HTML data, as compared to non-community indexing search engines which only index HTML information. If they search a local database of information, that information was added directly into this search database and not indexed online. This adding of information into a database is not an Internet indexing process. The search engine's design actually indexes the information without any vendor submission process. The community search engine truly goes out into the Internet and finds each merchant's URL and indexes the non-HTML information. Therefore, no Internet search is done on non-HTML information.

It is to be understood that the present invention is not limited to the embodiments described above, but encompasses any and all embodiments within the scope of the following claims.

We claim:

1. A client-side system for e-commerce, which integrates point-of-sale and Internet operations, comprising:
a merchant's computer having a processor, a memory coupled to the processor, and a computer readable medium coupled to the memory having computer readable program code means embodied therein;
computer readable program code means for generating an e-commerce website on the merchant's computer and uploading said website to a Web server;
computer readable program code means for maintaining a client-side database of the inventory of items offered for sale on the website and at a point-of-sale;
computer readable code means for updating said inventory database to reflect sales made on the website and at the point-ofsale; and
computer readable code means for reflecting changes on the website resulting from changes in the inventory of the items avalable for sale.

2. A system according to claim 1, wherein the means for generating a website comprises static ASCII text files created in HTML format on the merchant's computer and then uploaded from the merchant's computer to a Web server via the Internet standard File Transfer Protocol (FTP), said static ASCII text HTML files transferred from the Web server via the Hypertext Transfer Protocol (HTTP) to a Internet customer's computer having a Web browser, and said merchant's e-commerce website dynamically generated by the Web browser from the merchant's uploaded ASCII text HTML files.

3. A system according to claim 2, further including the Internet customer's Web browser, said system being configured such that said means for updating the inventory is initiated by a customer transaction relating to an item or items available for sale on the merchant's e-commerce website, thus resulting in a non-secure e-commerce Order, said Internet customer's Web browser transferring information about said non-secure e-commerce order to a third party's Web server via HTTP (Hypertext Transfer Protocol), which then transfers the transaction via the Internet to an electronic mail server identified by the merchant using SMTP (Simple Mail Transfer Protocol).

4. A system according to claim 3, wherein said system is configured such that said means to reflect changes on the website involves uploading updated pages for the website generated by the updated inventory database.

5. A system according to claim 3, wherein said system is configured such that said Internet customer's Web browser transfers information about said e-commerce order as a Non-Secure Order to a third party's web server via HTTP, which then transfers the non-secure order via the Internet to an electronic mail server using SMTP.

6. A system according to claim 3, wherein said system is configured such that said Internet customer's Web browser transfers information about said e-commerce order as a Secure Order via the Internet using the Secure Hypertext Transfer Protocol (HTTPS) to transfer said information to a Third Party Secure Transaction Payment Provider, who then transmits the secure order to the merchant's electronic mail server using SMTP.

7. A system according to claim 3, further comprising:
means for tracking company expenses, vendors, customers or employees;
means for generating various reports including, but not limited to, inventory detail, sales, returns, profit;
means for reordering items when quantities reach predetermined levels;
means for automatically calculating taxes and shipping charges; and
means for processing e-commerce and point-of-sale transactions, including cash sales, returns, invoices, credit memos, and payments.

8. A system according to claim 1 wherein said system is configured such that the merchant uses the system with multiple e-commerce websites or multiple points-of-sale that offer for sale items from a common inventory.

9. A system according to claim 1 wherein said system is configured such that the merchant uses the system in connection with an Intranet.

10. A system according to claim 1 wherein the system further includes search engine means for enabling a customer to search the merchant's website.

11. A system according to claim 10 wherein said system is configured such that the search engine means provides for the indexing and searching of merchant web sites.

12. A system to integrate point-of-sale and e-commerce website operations on a merchant's computer, having means to execute computer readable program codes and to communicate with a Web server, said system comprising:
a computer readable program code to construct and maintain an inventory database;
a computer readable program code to generate an e-commerce website;
a computer readable program code for updating inventory information in said database and on the website;
a computer readable program code for processing point-of-sale transactions;
a computer readable program code for processing e-commerce transactions, resulting in the data being in the same computer readable format as the point-of-sale transactions, and
a computer readable program code for transferring data about transactions and inventory information between said merchant's computer and the Web server to synchronize the inventory database and to update the website to reflect changes resulting from the processed transactions.

13. A system according to claim 12, wherein the transferred transactional data and inventory information are text files created statically on the merchant's computer.

14. A system according to claim 13, wherein said system is configured such that said integration further comprises transfer of data about transactions and inventory information between the merchant's Web server for electronic mail to the merchant's computer via the public Internet.

15. A system according to claim 14, wherein said system is further configured such that said integration further comprises data about transactions and inventory information being transferred from a general Internet user's computer to the merchant's secure transaction provider's computer via the public Internet, and then transferring said data and information between the merchant's secure transaction provider's computer to the merchant's electronic mail server via the public Internet.

16. A system according to claim 15, further comprising:
a computer readable program code for tracking company expenses, vendors, customers and employees;
a computer readable program code for generating various reports including, but not limited to, inventory detail, sales, returns, profit;
a computer readable program code for reordering items when quantities reach predetermined levels;
a computer readable program code for automatically calculating taxes and shipping charges; and
wherein said computer readable program code for processing e-commerce and point-of-sale transactions, includes code to process cash sales, returns, invoices, credit memos, and other payments.

17. A system according to claim 16, further comprising:
a computer readable code for enabling a customer to search merchant web sites.

18. A client-side program executable by a merchant's computer performing method steps for enabling an inventory management system to integrate point-of-sale and e-commerce operations on the merchant's website, comprising:
transferring information between the merchant's computer and a Web server linked to the merchant's website;
querying said website for inventory information;
retrieving inventory information corresponding to said query; and
integrating said inventory information from the website with inventory information maintained about the merchant's point-of-sale operations.

19. A program according to claim 18, further comprising:
processing point-of-sale transactions;
processing e-commerce transactions, with the data in the same computer readable format as the point-of-sale transactions; and
synchronizing the inventory information on the website with the point-of-sale operations.

20. A program according to claim 19, further comprising:
tracking company expenses;
generating various reports including, but not limited to, inventory detail, sales, returns, profit; and
reordering items when quantities reach predetermined levels.
